(19) United States
(12) Patent Application Publication
(10) Pub. No.: US 2022/0172634 A1
(43) Pub. Date: Jun. 2, 2022

(54) Educational Tool

(71) Applicant: Marlyn Andrew Morgan, Conroe, TX (US)

(72) Inventor: Marlyn Andrew Morgan, Conroe, TX (US)

(21) Appl. No.: 17/675,069

(22) Filed: Feb. 18, 2022

(51) Int. Cl. G09B 7/02; G09B 5/06

(52) U.S. Cl. CPC G09B 7/02; G09B 5/062

(57) ABSTRACT

Described herein is at least one non-transitory computer-readable medium comprising instructions to direct at least one processor to implement an educational tool. The at least one processor is directed to enable a user to choose a category and a level of difficulty to obtain a chosen category and a chosen level of difficulty. A database that stores rhyming riddles is accessed. The rhyming riddles are created by a plurality of users. The database is requested to randomly select a rhyming riddle that concerns a topic in the chosen category and has the chosen level of difficulty. The rhyming riddle is displayed on a screen along with a set of answer choices that includes the correct answer to the rhyming riddle. The user is enabled to select an answer choice from the set of answer choices. The educational tool determines if the answer choice is the correct answer to the rhyming riddle.

### TECHNICAL FIELD

The present disclosure relates generally to techniques for gaining knowledge. More specifically, the present techniques relate to gaining knowledge using an educational tool that promotes active learning.

### BACKGROUND ART

Passive learning is a method of learning in which the learner receives information and internalizes it. The learner is a passive recipient of the information. He or she does not take an active or participatory role in the learning process. Passive learning methods include reading a book, listening to a lecture, and watching a video.

### BRIEF DESCRIPTION OF THE DRAWINGS

FIGS. 1A and 1B depict a block diagram showing a medium that contains logic for implementing the educational tool.

FIGS. 2A-2C depict a flow diagram for implementing the logic contained in the medium shown in FIGS. 1A and 1B.

FIGS. 3A-3G show a table that lists the categories and subcategories that a user of the educational tool may select.

FIGS. 4A-4P are screenshots of an embodiment of the educational tool.

FIG. 5 is a process flow diagram of a method for providing a user with a rhyming riddle in a printed format.

FIGS. 6A-6D are screenshots of another embodiment of the educational tool.

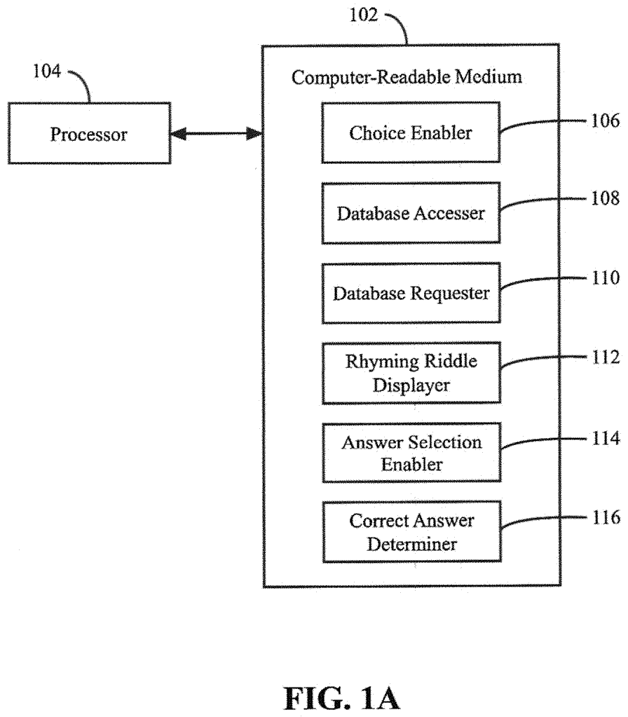

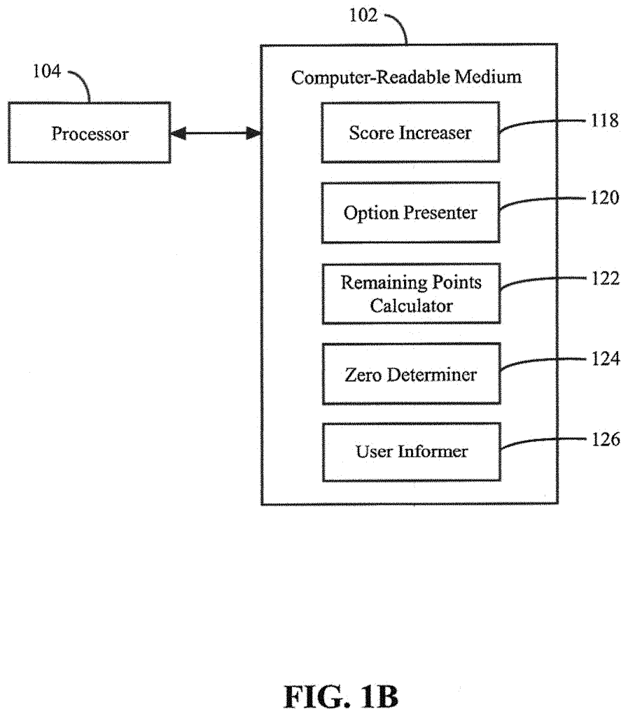

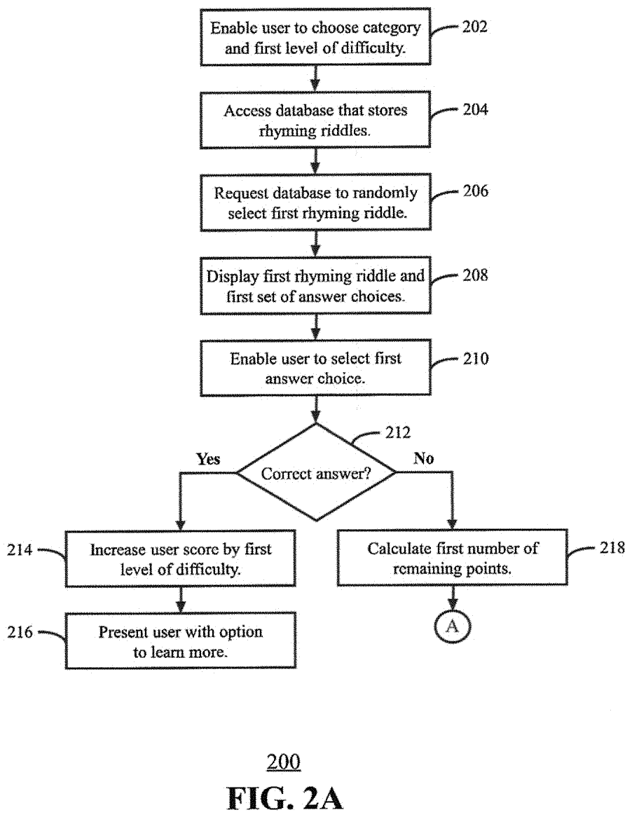

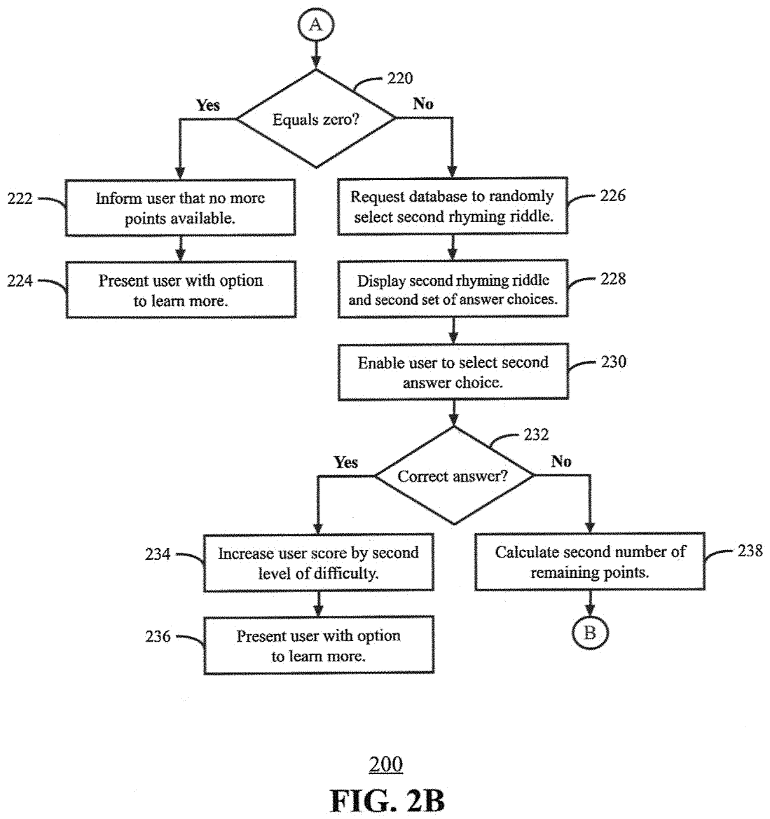

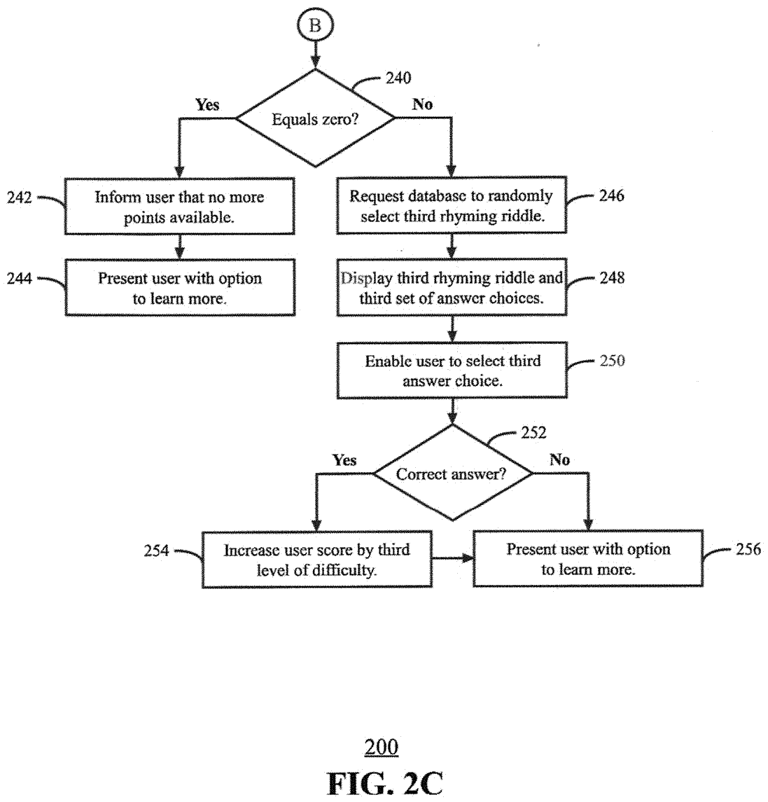

The same numbers are used throughout the disclosure and the figures to reference like features. Numbers in the 100 series refer to features originally found in FIGS. 1A and 1B; numbers in the 200 series refer to features originally found in FIGS. 2A-2C; and so on.

### DESCRIPTION OF THE EMBODIMENTS

Active learning is the opposite of passive learning. It involves the active engagement of the learner in the learning process. Examples of active learning practices include class discussion, small group discussion, case study, debate, writing, role playing, and problem solving. These practices result in experiential involvement of the learner in the learning process and engagement of higher-order thinking. Active learning is superior to passive learning in improving both comprehension and memory.

As noted above, problem solving is an example of an active learning practice. The learner's aptitude for problem solving improves as the learner solves more problems. Problem solving stimulates primitive neural pathways in the brain. These pathways are associated with an innate problem-solving ability. Frequent problem solving promotes and reinforces the use of the primitive pathways and the learner becomes more adept at solving problems.

Furthermore, when a problem is solved, the mesolimbic pathway releases dopamine into the nucleus accumbens, the brain's reward center. Dopamine is responsible for the positive feelings associated with accomplishment. When a learner solves a problem, he or she is rewarded with a surge of dopamine and the feelings of achievement, satisfaction, and contentment that ensue. The learner wants to experience these feelings again, so he or she engages in more problem solving. Hence, the development of problem-solving skills may be self-perpetuating. The learner engages in problem solving and experiences positive feelings which motivate him or her to solve more problems; he or she engages in more problem solving and experiences more positive feelings which motivate him or her to solve even more problems; and so on. All the while, the learner is becoming a more proficient problem solver.

Memory is also improved when a learner engages in frequent problem solving. The primitive neural pathways in the brain associated with problem solving are also associated with memory. These primitive pathways are stimulated when a learner solves a problem. Furthermore, factual information acquired while the pathways are stimulated is more likely to be retained. Hence, to improve the likelihood of retention, factual information should be included in the problem. Moreover, factual information is more apt to be retained when a problem is presented in certain formats. Accordingly, there is a need for an educational tool that allows a user to repeatedly solve problems that provide factual information in a format conducive to retention of the factual information.

The subject matter disclosed herein relates to an educational tool that poses a problem in a format that promotes learning and retention of the factual information contained in the problem. This disclosure describes a software application that uses a rhyming riddle format to present factual information to be learned and retained. For example, the software application may enable a user to choose a category and a level of difficulty to obtain a chosen category and a chosen level of difficulty. A database that stores rhyming riddles may be accessed. The rhyming riddles may be created by a plurality of users. The database may be requested to randomly select a rhyming riddle that relates to a topic in the chosen category and has the chosen level of difficulty. The rhyming riddle and a set of answer choices may be displayed on a screen. The set of answer choices may include the correct answer. The user may be allowed to select an answer choice from the set of answer choices and the software application may determine if the selected answer is the correct answer to the rhyming riddle.

FIGS. 1A and 1B depict a block diagram showing a medium that contains logic for implementing the educational tool. The medium 102 may be a non-transitory, computer-readable medium that stores code that may be executed by a processor 104. The medium 102 may include modules 106-126. A specific task may be performed when a module is executed. For example, a choice enabler 106 may enable a user to choose a category and a level of difficulty. A chosen category and a chosen level of difficulty may be obtained. A database accesser 108 may access a database that stores rhyming riddles created by a plurality of users. A database requester 110 may request the database to randomly select a rhyming riddle that concerns a topic in the chosen category and has the chosen level of difficulty. A rhyming riddle displayer 112 may display the rhyming riddle and a set of answer choices on a screen. The set of answer choices may contain the correct answer to the rhyming riddle. An answer selection enabler 114 may enable the user to select an answer choice from the set of answer choices. A correct answer determiner 116 may determine if the answer choice is the correct answer.

A score increaser 118 may increase the user's score when the correct answer determiner 116 determines that the selected answer choice is the correct answer. The user's score may be increased by a number of points equal to the chosen level of difficulty for the rhyming riddle. The chosen level of difficulty may be an integer that has a minimum value of one and a maximum value of five. Rhyming riddles may become more difficult to solve as the level of difficulty increases. For example, a rhyming riddle with a level of difficulty of two may be more difficult to solve than a rhyming riddle with a level of difficulty of one; a rhyming riddle with a level of difficulty of three may be more difficult to solve than a rhyming riddle with a level of difficulty of two; and so on. Furthermore, an option presenter 120 may present the user with an option to learn more about the correct answer when the correct answer is selected.

A remaining points calculator 122 may calculate a number of remaining points by subtracting one from the chosen level of difficulty for the rhyming riddle when the correct answer determiner 116 determines that the selected answer choice is not the correct answer. A zero determiner 124 may determine if the number of remaining points is equal to zero. A user informer 126 may inform the user that no more points are available when the number of remaining points is determined to be zero by the zero determiner 124. The option presenter 120 may present the user with the option to learn more about the correct answer to the rhyming riddle.

The user may be given another opportunity to select the correct answer when the zero determiner 124 determines that the number of remaining points is not equal to zero. Execution of modules 108-126 may be repeated. The database accesser 108 may once again access the database that stores rhyming riddles created by the plurality of users. The database requester 110 may request the database to randomly select a new rhyming riddle that concerns the same topic in the chosen category and has the same answer as the preceding rhyming riddle. However, the level of difficulty of the new rhyming riddle may be equal to the preceding level of difficultly minus one. In addition, the previously selected answer choice may be removed from the set of answer choices. As a result, the set of answer choices may contain one less choice. Hence, the new rhyming riddle may be easier to solve than the preceding rhyming riddle. Execution of modules 108-126 may continue in this manner until the user selects the correct answer, has zero remaining points, or has exhausted a preset number of attempts.

The block diagram of FIGS. 1A and 1B is not intended to indicate that the medium 102 is to include all of the modules shown. Furthermore, the medium 102 may include any number of additional modules not shown in FIGS. 1A and 1B depending on the details of the specific implementation.

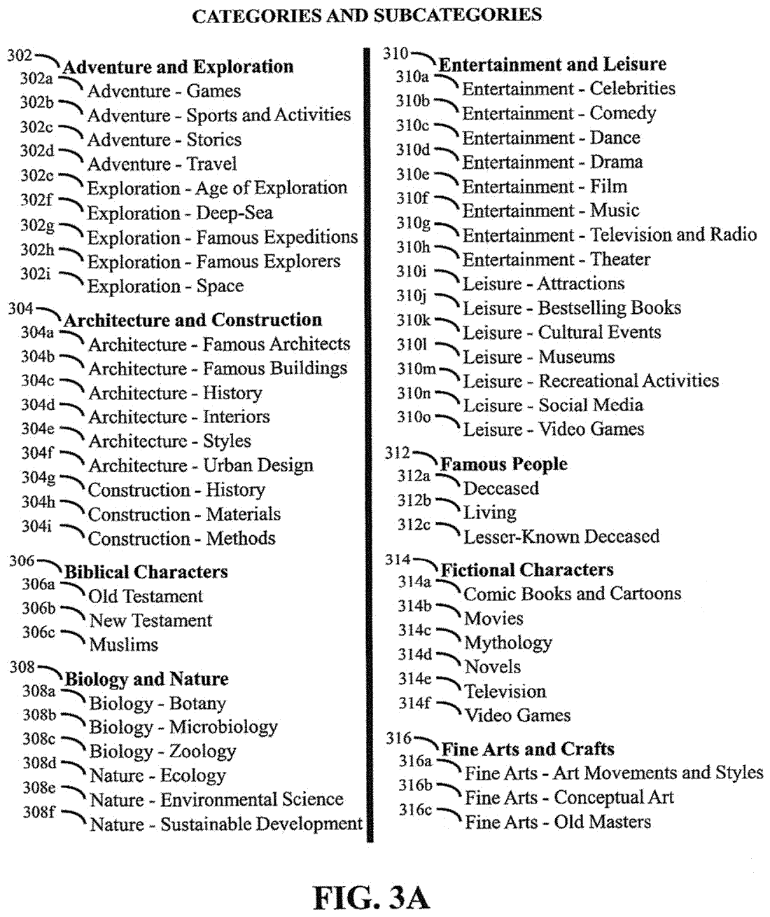

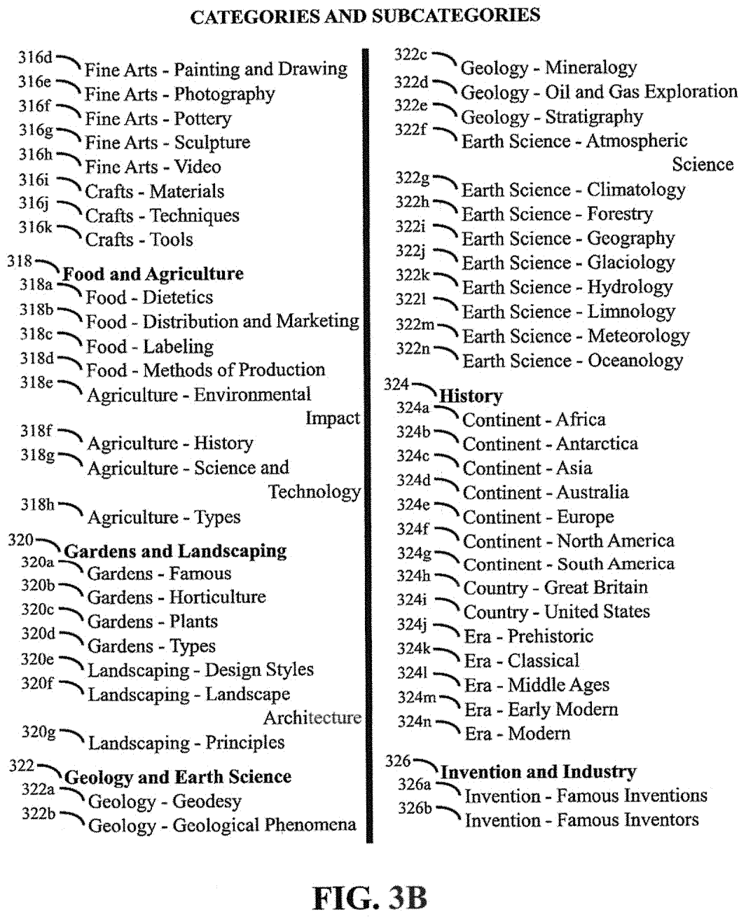

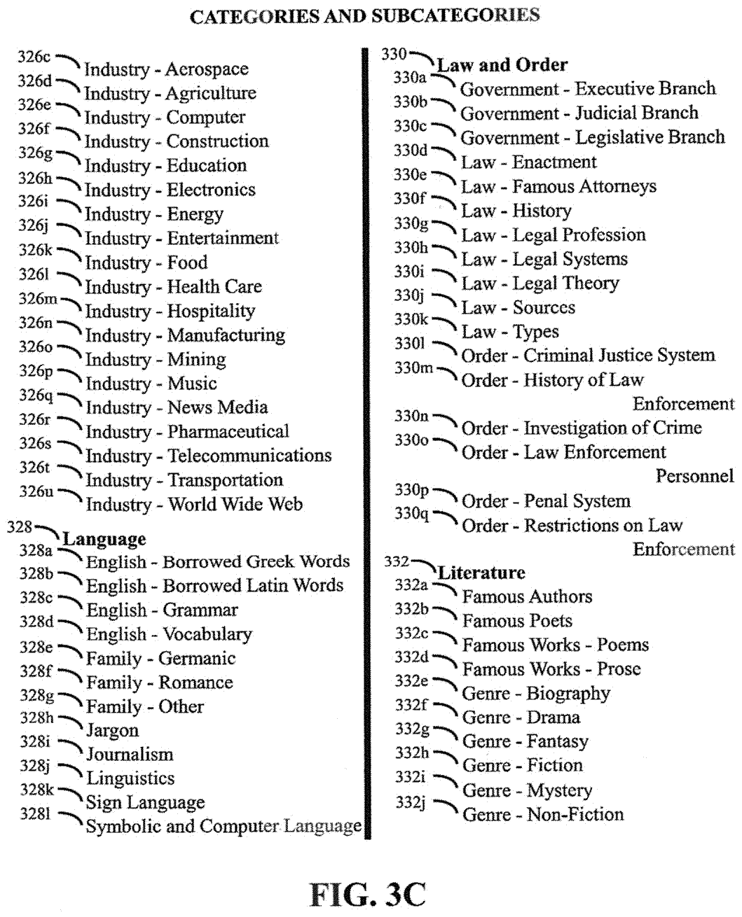

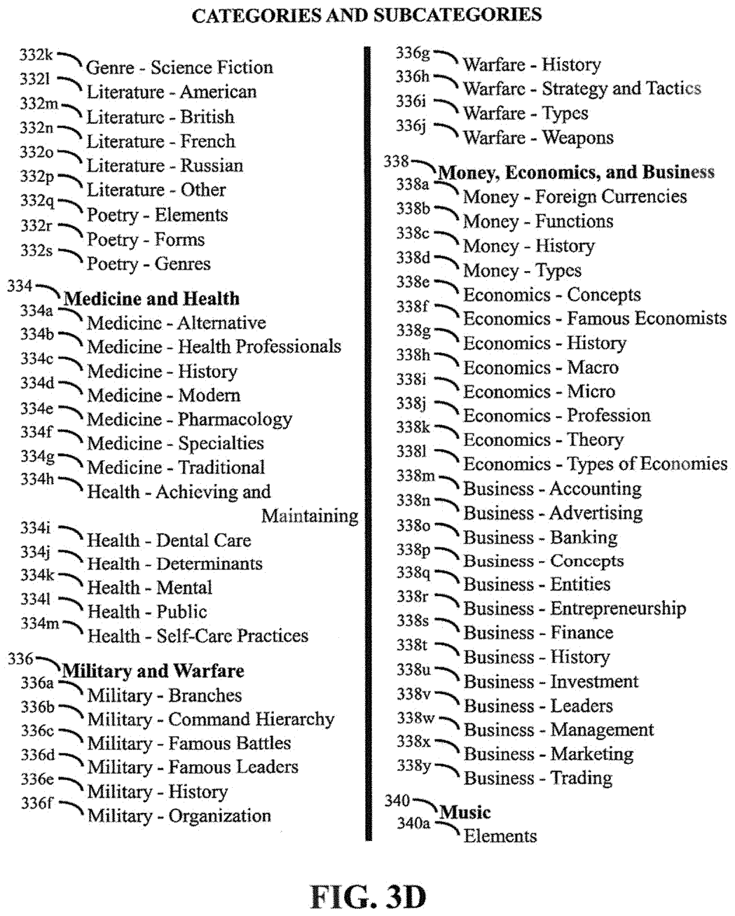

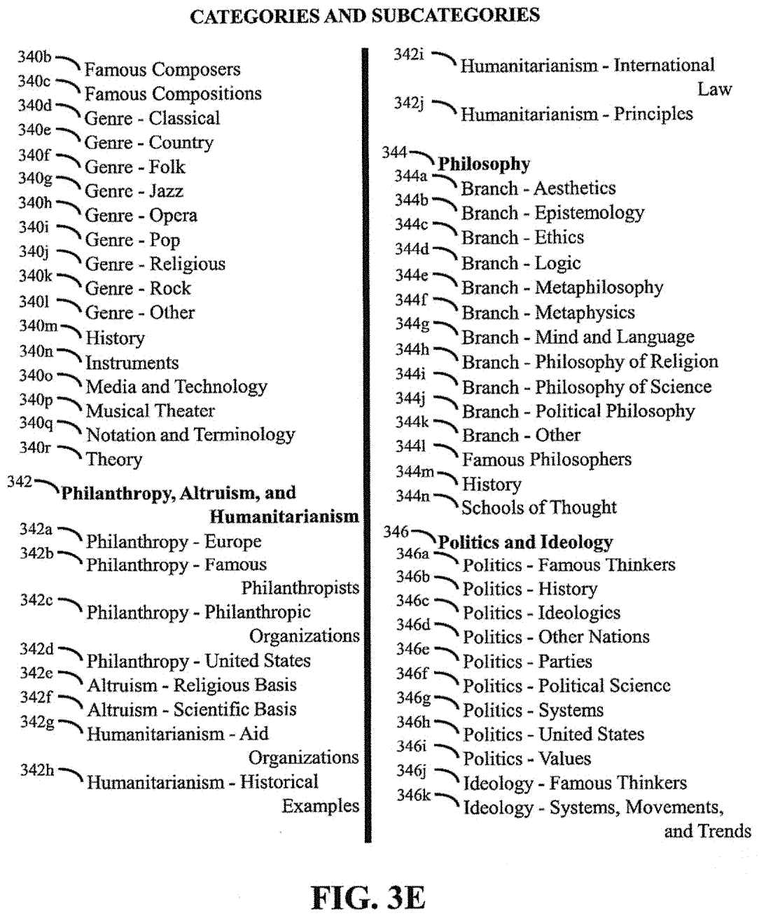

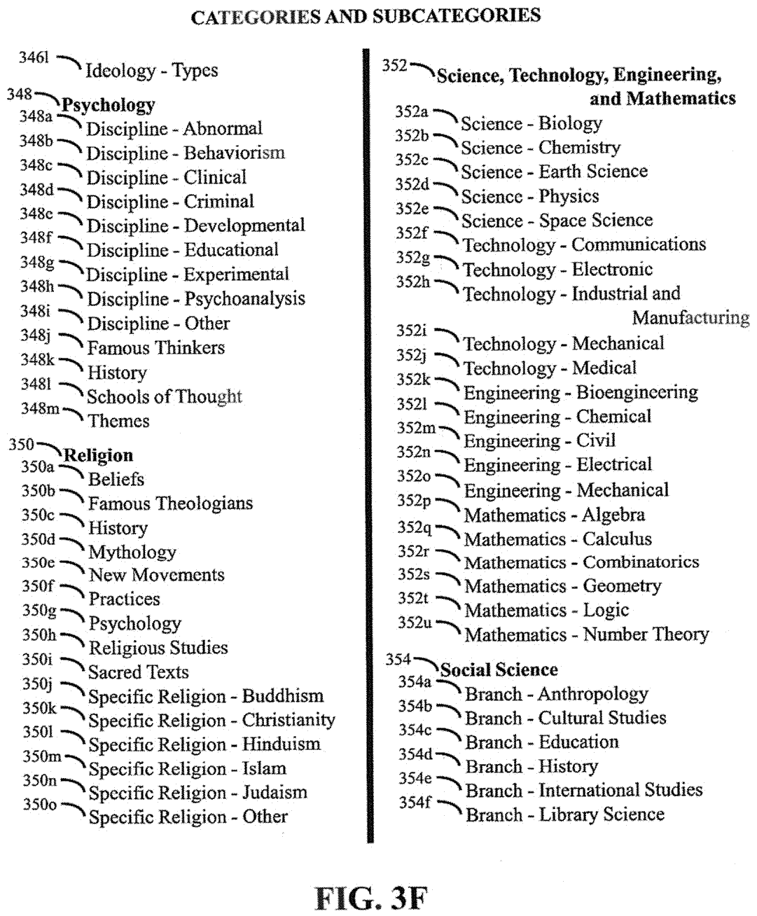

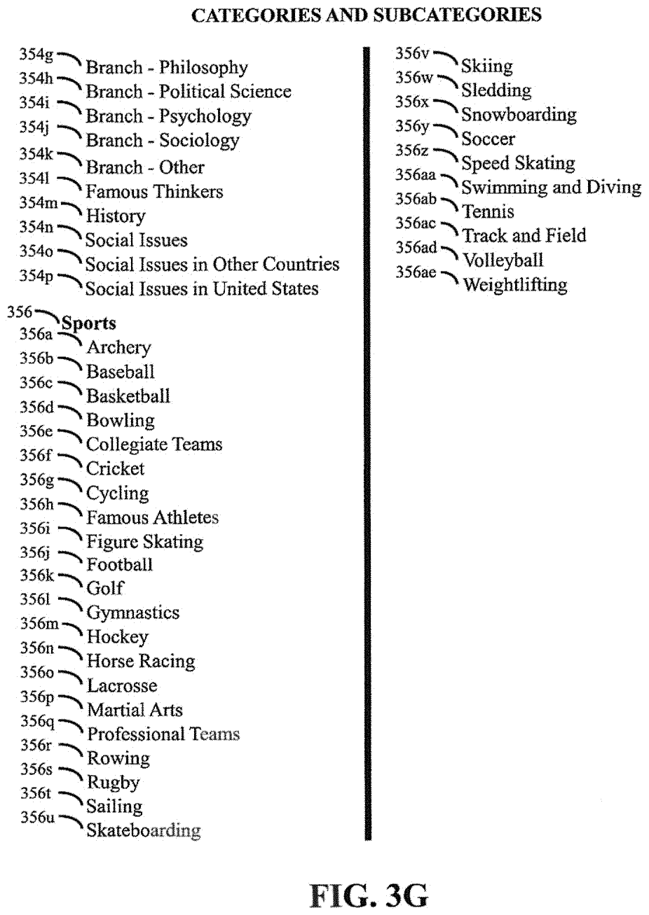

FIGS. 2A-2C depict a flow diagram for implementing the logic contained in the medium shown in FIGS. 1A and 1B. At block 202, the software application may enable a user to choose a category or subcategory and a first level of difficulty for a first rhyming riddle. FIGS. 3A-3G list the categories and subcategories that the user may select. All of the categories and subcategories may fall into five general categories: people, works, happenings, places, and principles. The general category of people may include famous people, living or deceased, who are renowned for their impact on civilization and the course of world history. The general category of works may include creations, contributions, and discoveries in the areas of architecture, art, film, literature, music, economics, government, law, medicine, science, or the like. The general category of happenings may include eras, movements, wars, famines, periods of prosperity, depressions, revolutions, causes, campaigns, or the like. The general category of places may include continents, regions, countries, states, cities, well-known locales, notable edifices, the sites of significant historical events, or the like. The general category of principles may include concepts a student has to master in subjects such as mathematics, biology, chemistry, physics, economics, government, art, music, or the like.

As explained above, the level of difficulty may be an integer that has a minimum value of one and a maximum value of five. As the level of difficulty increases, the rhyming riddles may become more difficult to solve. Rhyming riddles with a level of difficulty of one may be easiest to solve. They may relate to general knowledge and are appropriate for good high school students. New users may solve these rhyming riddles to acquaint themselves with the workings and features of the educational tool. Rhyming riddles with a level of difficulty of two may be easy to solve and are suitable for high school graduates who paid attention in class. Hard-to-solve rhyming riddles may have a level of difficulty of three and are appropriate for college graduates. Harder yet are rhyming riddles with a level of difficulty of four. They may be suitable for graduate students, users who have worked in a particular field for a number of years, and users who have engaged in considerable self-study of a specific subject. Rhyming riddles with a level of difficulty of five may be hardest to solve and are appropriate for specialists in a given field. A user of the educational tool should determine which level of difficulty is most suitable based on a self-assessment of the extent of his or her knowledge of the topics in the chosen category or subcategory. If the user wants to review similar topics, he or she may choose the same category or subcategory and a lower level of difficulty.

At block 204, the software application may access the database that stores rhyming riddles. The users of the educational tool may be encouraged to create rhyming riddles and contribute them to the database. As a result, the database may continue to expand as rhyming riddles are added by a plurality of users.

The database may be requested to randomly select a first rhyming riddle at block 206. The entire database may be searched for rhyming riddles that concern a topic in the category or subcategory chosen by the user at block 202 and have the first level of difficulty also chosen by the user at block 202. The rhyming riddles that meet these criteria may be formed into a first group. From this group, a rhyming riddle may be randomly selected and designated the first rhyming riddle provided it is not one of the previous 100 rhyming riddles presented to the user. Like all the rhyming riddles in the database, the first rhyming riddle may be composed of two to six lines of factual information about its topic. The factual information may be presented in a witty style which makes it more likely to be remembered by the user of the educational tool.

Rhyming may be used to capture and hold the user's attention. The rhyming format may highlight and connect the facts in the riddle. This format may be more likely to engage the user than a simple statement of the same facts. In addition, the user may be more apt to remember the facts presented in the riddle because the rhyming format makes the facts more memorable and the learning process more enjoyable. Furthermore, the riddle may have rhythm which has an innate appeal. Consequently, the rhythm of the riddle may join with its rhyme to enhance the effectiveness of the educational tool. Nursery rhymes, poems, songs, adages, mnemonics, or the like attest to the inherent ability of rhyme and rhythm to capture attention and aid memory.

At block 208, the first rhyming riddle and a first set of answer choices may be displayed. For example, the first set of answer choices may contain four choices. One of the four choices may be the correct answer to the first rhyming riddle. The position of the correct answer in the first set of answer choices may be randomly chosen. Hence, the position of the correct answer may not be part of a pattern that can be used to predict the position of the correct answers in subsequently displayed sets of answer choices. The three incorrect answer choices may be randomly selected from a group of answer choices having similar characteristics to the correct answer. In an embodiment, the answer to the rhyming riddle may be a famous deceased person. The three incorrect answers may be the same gender and nationality as the correct answer, may have lived in the same time period as the correct answer, and may be known for accomplishments similar to those of the correct answer. Furthermore, the first set of answer choices may exclude any incorrect answer choices that appeared in the sets of answer choices for the previous five rhyming riddles concerning the same topic. A screen may be used to display the first rhyming riddle and the first set of answer choices. For example, the screen may be the screen on the user's desktop computer, portable electronic device, or other electronic device having sufficient processing capability to execute the software application.

At block 210, the user may be enabled to select a first answer choice from the first set of answer choices. At block 212, the software application may determine if the first answer choice is the correct answer to the first rhyming riddle. The logic sequence 200 continues at block 214 when the first answer choice is the correct answer. At block 214, the software application may reward the user for selecting the correct answer by increasing his or her score by the first level of difficulty. At block 216, the user may be presented with an option to learn more about the correct answer. For example, when the topic of the rhyming riddle is a famous deceased person, a short biography may be displayed if the user selects the option to learn more.

The logic sequence 200 continues at block 218 when the first answer choice is not the correct answer. At block 218, a first number of remaining points may be calculated by subtracting one from the first level of difficulty. The software application may determine if the first number of remaining points is equal to zero at block 220.

The logic sequence 200 continues at block 222 when the first number of remaining points is equal to zero. When there are no remaining points, the user is not given a second opportunity to select the correct answer. At block 222, the user may be informed that no more points are available. At block 224, the user may be presented with the option to learn more about the correct answer.

The logic sequence 200 continues at block 226 when the first number of remaining points is not equal to zero. When points remain, the user is given a second opportunity to select the correct answer. At block 226, the database may be requested to randomly select a second rhyming riddle that concerns the same topic in the category or subcategory chosen by the user, has the same answer as the first rhyming riddle, and has a second level of difficulty. The search of the database at block 226 may be conducted in the same manner as the search at block 206. However, at block 226, the search criteria may include the second level of difficulty instead of the first level of difficulty. The second level of difficulty may be equal to the first level of difficulty minus one. Hence, the second rhyming riddle may be easier to solve than the first rhyming riddle.

At block 228, the second rhyming riddle and a second set of answer choices may be displayed on the same screen that displayed the first rhyming riddle and the first set of answer choices. The second set of answer choices may be equal to the first set of answer choices minus the first answer choice selected by the user at block 210. At block 230, the user may be enabled to select a second answer choice from the second set of answer choices. At block 232, the software application may determine if the second answer choice is the correct answer to the second rhyming riddle and the first rhyming riddle. The logic sequence 200 continues at block 234 when the second answer choice is the correct answer. At block 234, the software application may reward the user for selecting the correct answer by increasing his or her score by the second level of difficulty. However, the user may receive one point less than he or she would have received had he or she solved the first rhyming riddle. The user may be presented with the option to learn more about the correct answer at block 236.

The logic sequence 200 continues at block 238 when the second answer choice is not the correct answer. At block 238, a second number of remaining points may be calculated by subtracting one from the second level of difficulty. The software application may determine if the second number of remaining points is equal to zero at block 240. The logic sequence 200 continues at block 242 when the second number of remaining points is equal to zero. When there are no remaining points, the user is not given a third opportunity to select the correct answer. At block 242, the user may be informed that no more points are available. At block 244, the user may be presented with the option to learn more about the correct answer.

The logic sequence 200 continues at block 246 when the second number of remaining points is not equal to zero. When points remain, the user is given a third opportunity to select the correct answer. At block 246, the database may be requested to randomly select a third rhyming riddle that concerns the same topic in the category or subcategory chosen by the user, has the same answer as the first rhyming riddle and the second rhyming riddle, and has a third level of difficulty. The search of the database at block 246 may be conducted in the same manner as the search at block 226. However, at block 246, the search criteria may include the third level of difficulty instead of the second level of difficulty. The third level of difficulty may be equal to the second level of difficulty minus one. Accordingly, the third rhyming riddle may be easier to solve than the second rhyming riddle.

At block 248, the third rhyming riddle and a third set of answer choices may be displayed on the same screen that displayed the first rhyming riddle, the first set of answer choices, the second rhyming riddle, and the second set of answer choices. The third set of answer choices may be equal to the second set of answer choices minus the second answer choice selected by the user at block 230. At block 250, the user may be enabled to select a third answer choice from the third set of answer choices. At block 252, the software application may determine if the third answer choice is the correct answer to the third rhyming riddle, the second rhyming riddle, and the first rhyming riddle. The logic sequence 200 continues at block 254 when the third answer choice is the correct answer. At block 254, the software application may reward the user for selecting the correct answer by increasing his or her score by the third level of difficulty. However, the user may receive one point less than he or she would have received had he or she solved the second rhyming riddle and two points less than he or she would have received had he or she solved the first rhyming riddle. The logic sequence 200 continues at block 256.

The logic sequence 200 continues at block 256 when the third answer choice is not the correct answer. At block 256, the user may be presented with the option to learn more about the correct answer. Block 256 may be reached from block 252 or block 254 because blocks 246-254 represent the user's third and final opportunity to select the correct answer.

As shown in FIGS. 2A-2C, the educational tool may give the user a preset number of opportunities to select the correct answer. The educational tool may not provide the user with another opportunity, even if points remain, when the preset number of opportunities has been exhausted. In the embodiment shown in FIGS. 2A-2C, the preset number is equal to three and there are four initial answer choices. The preset number should be one less than the initial number of answer choices no matter the initial number of answer choices. As such, two answer choices will always remain if the user has to use the last of the preset number of opportunities. Accordingly, the user will have a 50:50 chance of selecting the correct answer. Whether the user selects the correct answer or the last of the incorrect answer choices, he or she will be given the option to learn more about the correct answer to the rhyming riddles.

In the embodiment shown in FIGS. 2A-2C, the user should choose a first level of difficulty of at least three so there will be enough remaining points to take advantage of all three opportunities if needed. For example, if the user chooses a first level of difficulty equal to three, the first number of remaining points will be equal to two. The user will be given a second opportunity to select the correct answer because the first number of remaining points is not equal to zero. The second number of remaining points will be equal to one. The user will be given a third opportunity to select the correct answer because the second number of remaining points is not equal to zero. In a similar fashion, the user will be given three opportunities if the first level of difficulty is equal to four or five. Conversely, if the user chooses a first level of difficulty equal to one or two, there will not be enough remaining points available to take advantage of all three opportunities. For example, if the user chooses a first level of difficulty equal to two, the first number of remaining points will be equal to one. The user will be given a second opportunity to select the correct answer because the first number of remaining points is not equal to zero. However, the second number of remaining points will be equal to zero and the user will not be given a third opportunity to select the correct answer. In a similar fashion, the user will not be given three opportunities if the first level of difficulty is equal to one. The user will be given only one opportunity because the first number of remaining points will be equal to zero.

The scoring system implemented by the software application may encourage use of the educational tool. The system may reward the user for selecting the correct answer to a rhyming riddle, but does not penalize him or her for choosing an incorrect answer choice. In the present embodiment, when the correct answer is selected, the level of difficulty of the rhyming riddle may be added to the user's score. However, the user's score is not reduced when an incorrect answer choice is selected. Hence, the discouragement that may accompany the loss of points may be avoided. The user may still become dispirited if he or she chooses a series of incorrect answer choices. To reduce the possibility of disappointment, the educational tool may suggest that the user choose a lower level of difficulty for the first rhyming riddle if he or she has selected a preset number of consecutive incorrect answer choices. For example, the preset number is equal to fifteen. When the user has selected the incorrect answer to fifteen consecutive rhyming riddles, the educational tool displays a message that encourages the user to choose a lower level of difficulty for the first rhyming riddle. The user may select a lower level of difficulty, but his or her selection of successive incorrect answer choices may continue. In this instance, the educational tool may recommend that the user choose a different category or subcategory for the first rhyming riddle once he or she has selected the preset number of successive incorrect answer choices. For example, the user may select the incorrect answer to another fifteen consecutive rhyming riddles even though he or she has chosen a lower level of difficulty for the first rhyming riddle. Consequently, the educational tool displays a message that encourages the user to choose another category or subcategory. The user should choose a category or subcategory that contains rhyming riddles he or she is more likely to answer correctly. These measures should lessen the likelihood that users will become discouraged and discontinue their utilization of the educational tool, thereby denying themselves an opportunity to learn.

As discussed above, the user should choose a first level of difficulty of at least three if he or she wants to have three opportunities to select the correct answer. Accordingly, the user will have the maximum number of opportunities to solve a more difficult rhyming riddle. Furthermore, with each opportunity, the rhyming riddle may become easier to solve. For example, if a first level of difficulty of four is chosen, the educational tool may present the user with a very difficult rhyming riddle and a set of four answer choices. If the user selects a first incorrect answer choice, the rhyming riddle with the level of difficulty of four may be replaced by a rhyming riddle with a level of difficulty of three. In addition, the first incorrect answer choice may be removed from the set of answer choices so that three answer choices remain. If the user selects a second incorrect answer choice, the rhyming riddle with the level of difficulty of three may be replaced by a rhyming riddle with a level of difficulty of two. The second incorrect answer choice may be removed from the set of answer choices so that two answer choices remain. Hence, if the user selects a first level of difficulty of at least three, he or she may be given all three opportunities to select the correct answer and the rhyming riddle may become easier to solve with each opportunity. As a result, the user is more likely to choose the correct answer and less likely to become frustrated. Accordingly, there is a greater likelihood that the user will learn and retain the factual information contained in the rhyming riddles.

The present embodiment may promote learning in other ways. For example, the software application may supplement the information presented in the brief description of the correct answer that is displayed when the user selects the option to learn more. At the end of the brief description, there may be a button which reads “Another Rhyming Riddle About the Same Topic” and another button which reads “Search Online.” Selection of either button may provide additional information about the correct answer. The user may augment the information gained by considering the rhyming riddle and the brief description by selecting either button when the correct answer is of particular interest to him or her.

Furthermore, the option to search online may be available to a user who is presented with the final rhyming riddle in a series of rhyming riddles concerning the same topic and he or she still cannot determine the correct answer. For example, if the user has three opportunities to select the correct answer, he or she may search online when two opportunities have been used and the third rhyming riddle fails to make the correct answer evident. Using the search engine of his or her choice, the user may search for keywords taken from the rhyming riddles. If this search does not identify the correct answer, the user may search for the answer choices. The user may return to the interface for the software application, select the correct answer, and gain the remaining points.

This option is referred to as “research mode” and has several advantages. The user avoids the frustration caused by a third incorrect answer. In addition, the user is learning about the correct answer the entire time he or she is conducting the online search.

The embodiment described above may be implemented by executing a software application installed on a desktop computer, portable electronic device, or other electronic device having sufficient processing capability. The portable electronic device may be a laptop computer, tablet, notebook, smart phone, smart watch, or the like. The software application may be downloaded from an application distribution platform (“app store”) or a website dedicated to the educational tool.

FIGS. 3A-3G show a table that lists the categories and subcategories that a user of the educational tool may select. A user may select a subcategory to narrow the focus of the rhyming riddles that he or she attempts to solve. For example, the user may be interested in solving rhyming riddles about U.S. history. He or she would select the subcategory that relates to U.S. history included in the broad category that relates to world history from the prehistoric era to the modern era. If the user chooses the category instead, he or she may be presented with only an occasional rhyming riddle that concerns U.S. history.

The table shown in FIGS. 3A-3G includes category 302 “Adventure and Exploration” and its subcategories 302a-302i; category 304 “Architecture and Construction” and its subcategories 304a-304i; category 306 “Biblical Characters” and its subcategories 306a-306c; category 308 “Biology and Nature” and its subcategories 308a-308f; category 310 “Entertainment and Leisure” and its subcategories 310a-310o; category 312 “Famous People” and its subcategories 312a-312c; category 314 “Fictional Characters” and its subcategories 314a-314f; category 316 “Fine Arts and Crafts” and its subcategories 316a-316k; category 318 “Food and Agriculture” and its subcategories 318a-318h; category 320 “Gardens and Landscaping” and its subcategories 320a-320g; category 322 “Geology and Earth Science” and its subcategories 322a-322n; category 324 “History” and its subcategories 324a-324n; category 326 “Invention and Industry” and its subcategories 326a-326u; category 328 “Language” and its subcategories 328a-328l; category 330 “Law and Order” and its subcategories 330a-330q; category 332 “Literature” and its subcategories 332a-332s; category 334 “Medicine and Health” and its subcategories 334a-334m; category 336 “Military and Warfare” and its subcategories 336a-336j; category 338 “Money, Economics, and Business” and its subcategories 338a-338y; category 340 “Music” and its subcategories 340a-340r; category 342 “Philanthropy, Altruism, and Humanitarianism” and its subcategories 342a-342j; category 344 “Philosophy” and its subcategories 344a-344n; category 346 “Politics and Ideology” and its subcategories 346a-346l; category 348 “Psychology” and its subcategories 348a-348m; category 350 “Religion” and its subcategories 350a-350o; category 352 “Science, Technology, Engineering, and Mathematics” and its subcategories 352a-352u; category 354 “Social Science” and its subcategories 354a-354p; and category 356 “Sports” and its subcategories 356a-356ae. This list is not exhaustive. As users contribute rhyming riddles, new categories and subcategories may be added to the list.

The educational tool may have a multi-screen user interface that enables the user to choose a category or subcategory for the topic of the first rhyming riddle. In an embodiment, the categories 302-356 may be listed on a screen of the multi-screen user interface. The user may select a category from this screen. The user may opt to limit the topic of the first rhyming riddle to a specific subcategory in the chosen category. The screen displaying categories 302-356 may be replaced by a second screen that lists the subcategories in the chosen category and the user may select a subcategory from the second screen. The software application may randomly select a rhyming riddle that relates to any topic in the chosen subcategory. If the user does not select a subcategory, the software application may randomly select a rhyming riddle that relates to any topic in any subcategory of the chosen category.

For example, the user may want to solve rhyming riddles that focus exclusively on famous poets. Toward this end, the user selects category 332 “Literature” from the screen that lists categories 302-356 and subcategory 332b “Famous Poets” from the screen that lists subcategories 332a-332s. The software application randomly selects a first rhyming riddle from subcategory 332b “Famous Poets” and presents it to the user. The topic of the first rhyming riddle may be William Shakespeare, Emily Dickinson, Sylvia Plath, Oscar Wilde, Walt Whitman, or the like. If the user fails to specify subcategory 332b “Famous Poets,” the topic of the first rhyming riddle may by any topic in any subcategory 332a-332s. As the software application randomly selects rhyming riddles, the user may be presented with an occasional rhyming riddle from subcategory 332b “Famous Poets” interspersed among rhyming riddles having any topic from the subcategories 332a and 332c-332s.

To best suit his or her learning style, the user may customize the way he or she interacts with the educational tool. The user may attempt to solve rhyming riddles using a single opportunity instead of a series of three opportunities as discussed above. When the user selects the single-opportunity mode, each rhyming riddle may be from a different category or subcategory listed in FIGS. 3A-3G. The rhyming riddles may have the same level of difficulty. Alternatively, the user may opt to solve rhyming riddles in his or her areas of interest by designating a default group of categories and subcategories. For example, the default group may include category 352 “Science, Technology, Engineering, and Mathematics;” category 338 “Money, Economics, and Business;” and category 340 “Music.” The user may select a level of difficulty for the rhyming riddles from each category or subcategory in the default group. Accordingly, the user may solve rhyming riddles that are appropriate for the extent of his or her knowledge in each default category or subcategory. For example, the user may choose a level of difficulty of two for rhyming riddles from category 352 “Science, Technology, Engineering, and Mathematics;” a level of difficulty of three for rhyming riddles from category 338 “Money, Economics, and Business;” and a level of difficulty of four for rhyming riddles from category 340 “Music.” Hence, the user may be presented with rhyming riddles from each default category or subcategory that have the selected level of difficulty. Furthermore, the user may be presented with rhyming riddles that have lower levels of difficulty because they increase the number of rhyming riddles available to the user, they improve the user's score in that he or she is more likely to answer them correctly, and they prevent the user from becoming discouraged if he or she cannot solve the rhyming riddles that have the level of difficulty he or she selected.

The user may further restrict the scope of the rhyming riddles he or she will attempt to solve. The selection of a subcategory restricts the scope of the rhyming riddles to a certain extent. However, the scope may be restricted even more. In an embodiment entitled “Focus,” the user may solve rhyming riddles that focus on a particular topic from any of the categories or subcategories shown in FIGS. 3A-3G. The user may choose a category from categories 302-356 listed on a screen of the multi-screen user interface. The next screen may display the subcategories of the selected category. The user may choose a subcategory from this screen. A third screen may enable the user to confine the scope of the rhyming riddles to a particular topic in the chosen subcategory. Using the third screen, the user may enter keywords that describe the topic. The name of the topic may be one of the keywords. The software application may search the database for rhyming riddles that contain the keywords associated with the topic. The rhyming riddles found by the search may be formed into a group. A rhyming riddle may be randomly selected from this group and presented to the user. Alternatively, the rhyming riddles in the group may be presented one by one and the user may select those rhyming riddles he or she wants to solve at that time or at a later time.

For example, the user may want to learn about the first woman to win the Nobel Prize in Chemistry. Hence, the user would select category 352 “Science, Technology, Engineering, and Mathematics” from the screen that lists categories 302-356 and subcategory 352b “Science-Chemistry” from the screen that lists subcategories 352a-352u. Using the screen that allows the input of keywords, the user would enter “first woman,” “Nobel Prize,” or the like. The search of the database would result in a group of rhyming riddles that relate to Marie Curie, the recipient of the 1911 Nobel Prize in Chemistry for her discovery of the elements polonium and radium. The rhyming riddles may be presented one by one and the user may choose those rhyming riddles he or she wants to solve to learn more about Marie Curie. As this example indicates, the user may narrow the topic of the rhyming riddles as much as needed to meet his or her learning objectives.

The “Focus” option may be especially useful in academic settings. For example, a teacher may customize rhyming riddles to be presented to the students in his or her class. In particular, the teacher may tailor the scope of the rhyming riddles depending on their intended purpose. The rhyming riddles may be used to review a topic, introduce a new topic, or augment classroom instruction. Furthermore, the customized rhyming riddles may provide the basis for competitive play involving the entire class. The students may compete to see who answers the most rhyming riddles correctly. Consequently, students may become more motivated to learn so that they will perform better during competitive play. Furthermore, competition may make learning enjoyable. As a result, the students may be more likely to retain the factual information contained in the rhyming riddles presented during competitive play.

There may also be considerable use of the “Focus” option when competitive play occurs in a social setting. For example, users wanting to engage in competitive play may gather at a social club and form groups. Each group may have a leader who customizes the scope of the rhyming riddles presented to the group during competitive play. The leader may choose a topic familiar to the group and use the “Focus” option to narrow the scope of the rhyming riddles. However, if the user selects a topic that is new to the group, he or she may have the “Focus” option search the database for rhyming riddles that are more general in scope. As the group becomes more acquainted with the topic, the leader may use the “Focus” option to limit the scope of the rhyming riddles. Competition may make it more enjoyable to utilize the educational tool. Consequently, a user may repeatedly engage in competitive group play and continually add to his or her knowledge base.

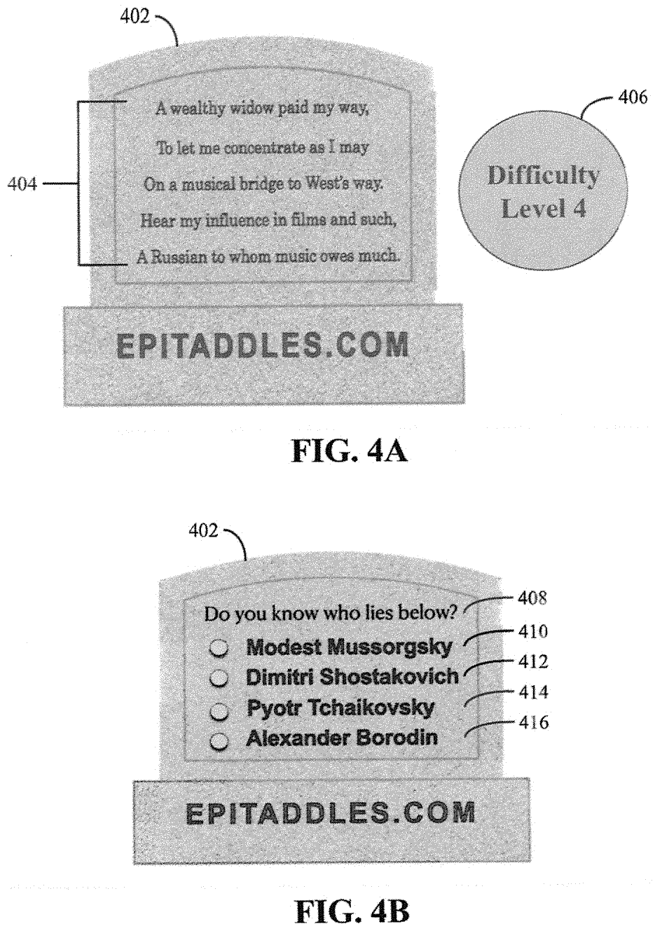

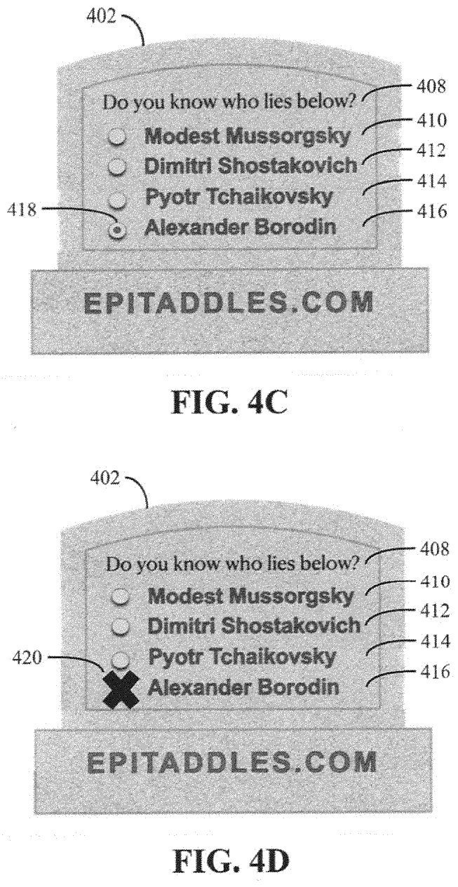

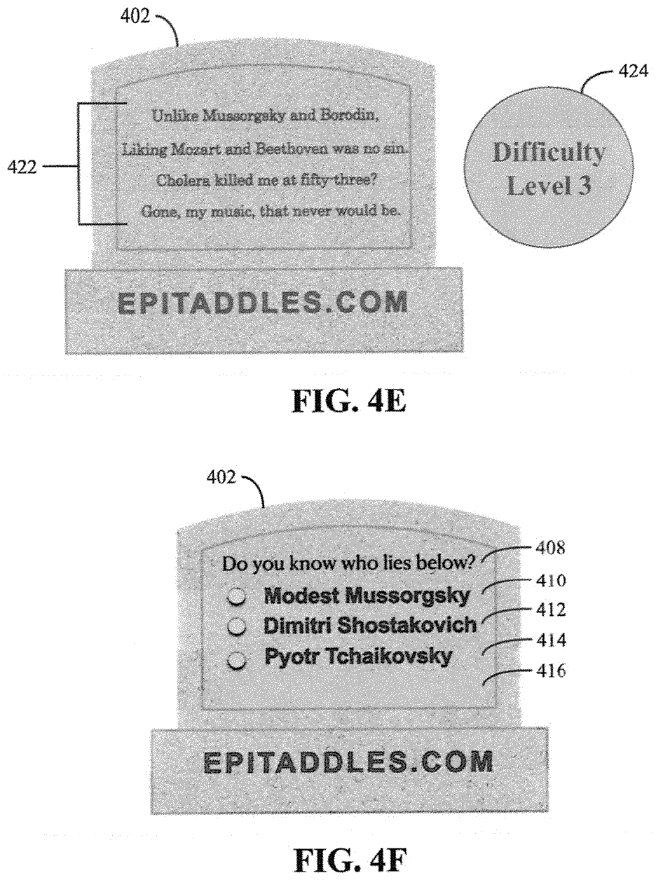

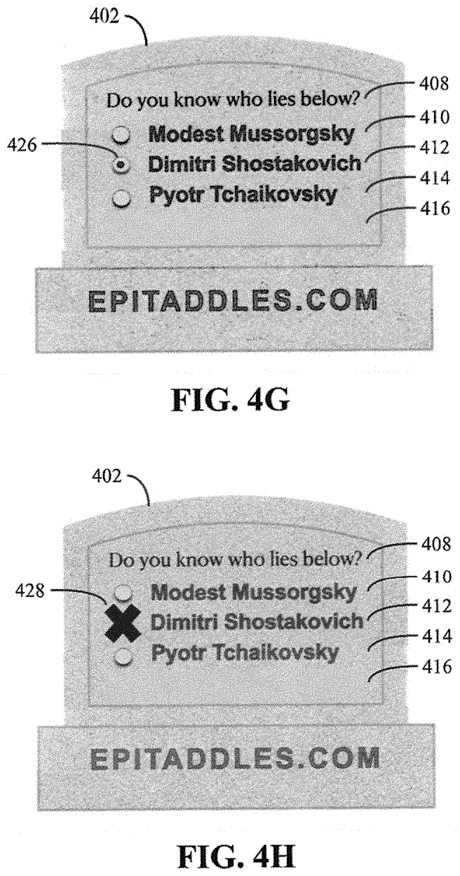

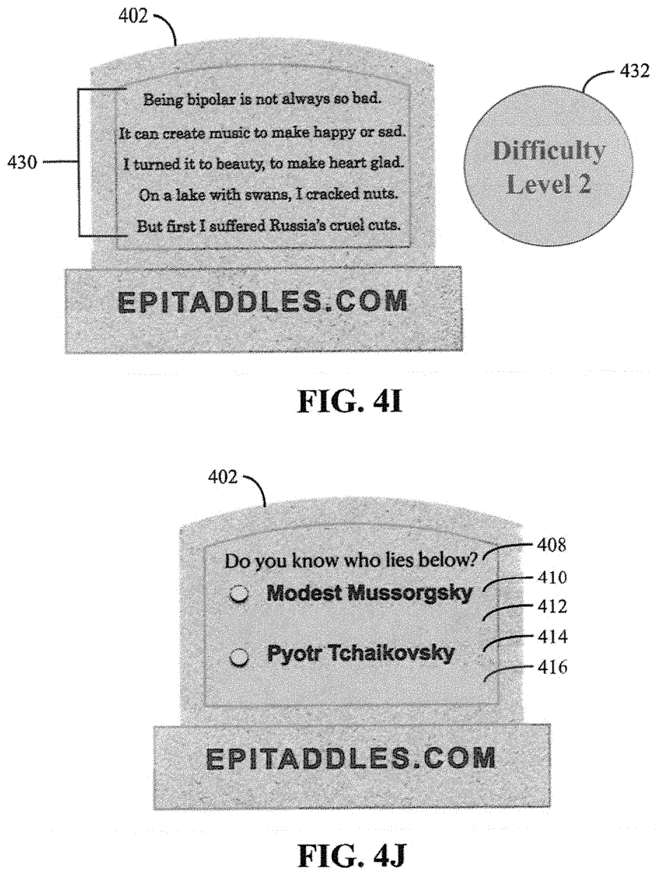

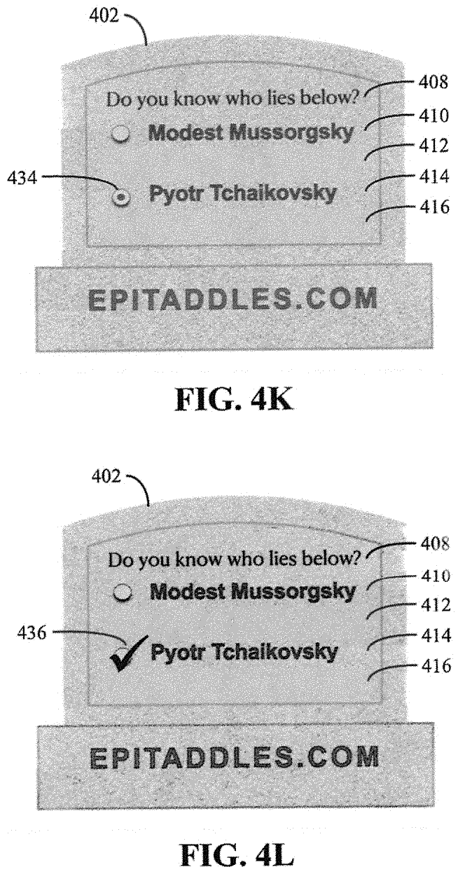

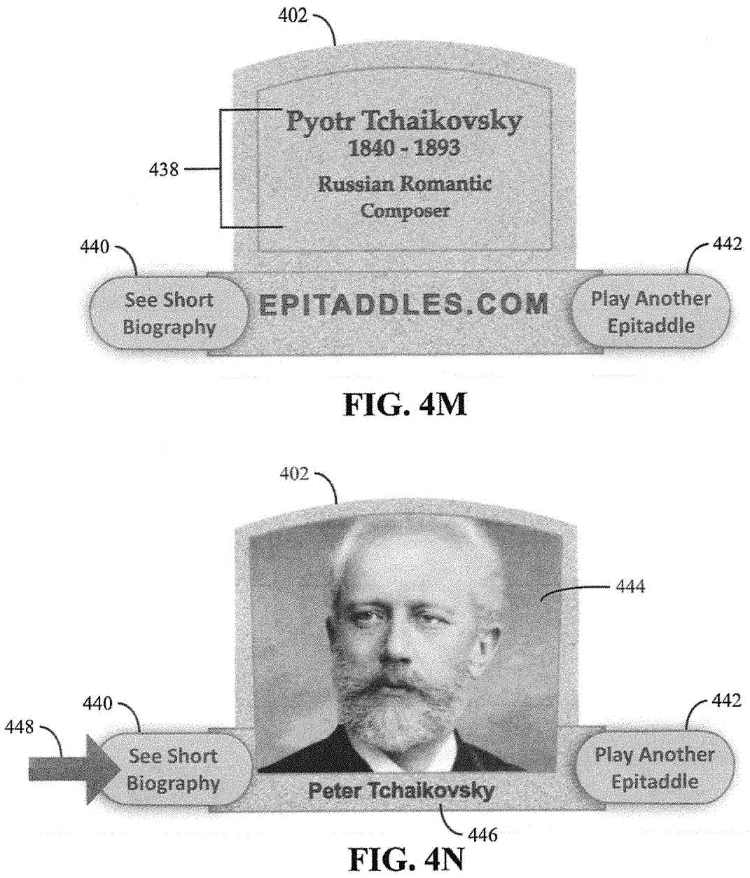

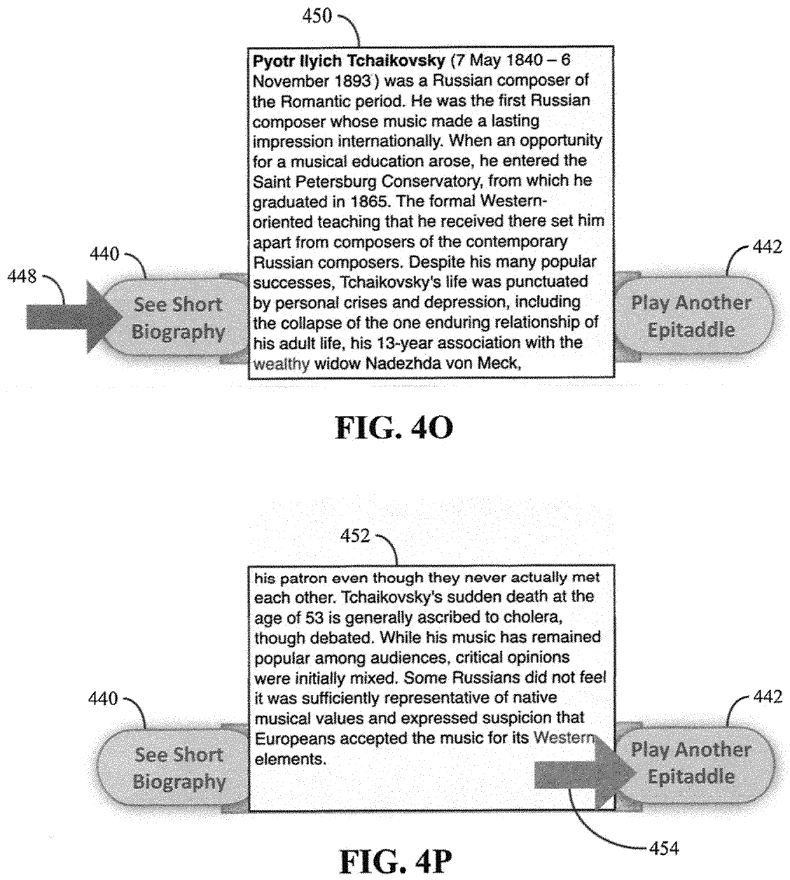

There may be other embodiments that allow a user to customize his or her interaction with the educational tool. For example, the user may choose an option entitled “People.” He or she may be presented with rhyming riddles that concern people who are central to the events, discoveries, products, and creations that helped shape civilization. The famous people may be living or deceased. In the embodiment shown in FIGS. 4A-4P, the user may be presented with rhyming riddles that include factual information about famous deceased people. As the user attempts to solve these rhyming riddles, he or she learns about the famous deceased people who are the subjects of the rhyming riddles.

Alternatively, the user may choose an option entitled “Works.” He or she may be presented with rhyming riddles that relate to discoveries, contributions, products, creations, or the like. The focus of the rhyming riddles may be the works themselves, not the people involved. An option entitled “Happenings” may also be available to the user. When this option is chosen, the user may be presented with rhyming riddles that concern events and their outcomes and impacts. In particular, the topic of the rhyming riddles may include periods of history, eras, wars, revolutions, booms, busts, depressions, famines, movements, campaigns, causes, or the like that changed a society's foundation, underlying philosophy, economic thinking, way of life, or the like. A user may select another option entitled “Places.” He or she may be presented with rhyming riddles that relate to continents, regions, countries, states, cities, locales, edifices, or the like associated with people, works, or happenings. In yet another embodiment, the user may select an option entitled “Principles.” When this option is selected, the user may be presented with rhyming riddles that concern the fundamental concepts that a student needs to master in academic disciples such as geography, grammar, government, economics, music, biology, chemistry, physics, mathematics, law, medicine, or the like.

When the user chooses the “People” option, the educational tool may select rhyming riddles from the user's default categories and subcategories that focus exclusively on people. When the user chooses the “Works” option, the educational tool may select rhyming riddles from the user's default categories and subcategories that focus exclusively on works. Similar statements may be made concerning the options entitled “Happenings,” “Places,” and “Principles.” The user-specified levels of difficulty for the default categories and subcategories may apply to the selected rhyming riddles. Hence, a rhyming riddle concerning a person, work, happening, place, or principle selected from a particular default category or subcategory may have the user-specified level of difficulty for that default category or subcategory. Alternatively, when the user chooses an option, he or she may provide a level of difficulty for the rhyming riddles that the educational tool will select. For example, when the user chooses the option “Happenings,” he or she may choose a level of difficulty of three. Accordingly, a rhyming riddle that focuses on happenings may have a level of difficulty of three, regardless of the default category or subcategory that is the source of the rhyming riddle.

There may be additional embodiments that allow a user to customize his or her learning experience. If the user chooses an option entitled “Connections,” the educational tool may choose a topic and form a group of rhyming riddles that relate to a person, work, happening, place, or principle associated with the topic. The educational tool may select the topic from the user's default categories or subcategories. For example, one of the user's default subcategories may be subcategory 326a “Invention-Famous Inventions” included in category 326 “Invention and Industry.” The educational tool may select a topic from subcategory 326a. If the topic “incandescent light bulb” is selected, the educational tool may present the user with rhyming riddles that concern (1) Thomas Edison, the inventor of the first practical incandescent light bulb (“light bulb”) (person); (2) Edison's invention of the light bulb (work); (3) the radical transformation of society that followed the invention of the light bulb (happening); (4) Menlo Park, New Jersey, the location of Edison's laboratory where he invented the light bulb (place); and (5) the physics of incandescence (principle). Hence, the “Connections” option may enable a user to gain a more comprehensive understanding of a topic by presenting the user with rhyming riddles that concern different aspects of the topic.

When the user chooses the “Connections” option, he or she may choose a level of difficulty for all the rhyming riddles selected by the educational tool. Consequently, a rhyming riddle may have the chosen level of difficulty, regardless of whether it relates to a person, work, happening, place, or principle. Alternatively, the user may choose a level of difficulty for each type of rhyming riddle. For example, the user may choose a level of difficulty of four for rhyming riddles that concern a person; a level of difficulty of two for rhyming riddles that concern a work; a level of difficulty of three for rhyming riddles that concern a happening; a level of difficulty of three for rhyming riddles that concern a place; and a level of difficulty of two for rhyming riddles that concern a principle.

There may be even more embodiments that allow a user to customize his or her learning experience. An option entitled “Yesteryears” may present the user with rhyming riddles that reference significant events that happened in the same year, period, or epoch. The user may solve these rhyming riddles by selecting the year, period, or epoch in which the events occurred. The year, period, or epoch may date from Before Common Era (BCE) to the present. For example, the “Yesteryears” option may display a rhyming riddle that refers to the inauguration of Richard Nixon; Neil Armstrong's first steps on the Moon; and a music and art festival held near Woodstock, N.Y. The user may solve this rhyming riddle by selecting the correct year “1969” from the set of answer choices. Hence, the “Yesteryears” option may enable the user to learn the years, periods, or epochs in which significant events occurred.

In some embodiments, the user may allow the educational tool to select the topics of the rhyming riddles based upon his or her past performance. Using artificial intelligence (AI), the educational tool may learn about the user and select rhyming riddles that optimize his or her learning experience. For example, the educational tool may identify those subcategories that include rhyming riddles that (1) the user consistently solves correctly; (2) the user consistently solves incorrectly; or (3) the user avoids altogether. In the first instance, the educational tool may present the user with difficult rhyming riddles from the identified subcategories. The rhyming riddles may have a level of difficulty of four or five to keep the user interested and engaged in the problem-solving process. The educational tool may present the user with an occasional rhyming riddle that has a level of difficulty of one, two, or three to review and reinforce basic concepts.

In the second instance, the educational tool may present the user with easy-to-solve rhyming riddles from the identified subcategories. Occasionally, the user may select the correct answer to one of these rhyming riddles. When this happens, the educational tool may analyze the rhyming riddle and compile a list of its characteristics (such as length, style, presence of certain words, or the like). With time, the educational tool may determine the characteristics common to the rhyming riddles solved correctly by the user and search the database for rhyming riddles that possess the same characteristics. The rhyming riddles may be grouped and the educational tool may present the user with rhyming riddles selected exclusively from the group that is formed. As the user contemplates rhyming riddles from this group, he or she may begin to learn about topics in the identified subcategories. Once the easy-to-solve rhyming riddles have been mastered, the educational tool may present the user with more difficult rhyming riddles. The educational tool may lengthen the list of characteristics shared by the rhyming riddles that have been solved correctly and expand the group from which it selects rhyming riddles to present to the user. As the user encounters more rhyming riddles that vary in content, he or she may continue to learn about topics in the identified subcategories. The user may become very knowledgeable despite an initial inability to solve rhyming riddles relating to these topics.

In the third instance, the educational tool may pique the user's curiosity about the subcategories he or she typically avoids. Toward this end, the educational tool may analyze the rhyming riddles from these subcategories and identify those rhyming riddles that are most often answered correctly by other users. The rhyming riddles may be slowly introduced to the user who is more apt to solve them given the tendency of other users to answer them correctly. As the user solves these rhyming riddles, he or she may acquire enough knowledge to become interested in the subcategories he or she was initially disinclined to select. The user may correctly answer even more rhyming riddles from the identified subcategories. Hence, the user may develop an aptitude for solving rhyming riddles from subcategories he or she previously avoided.

In most of the embodiments discussed so far, the educational tool has been utilized by a single user. Alternatively, the educational tool may be used by a group in a collaborative learning mode. The group may include a leader and a maximum of 24 members. The educational tools of the members may be linked to the educational tool of the leader who specifies the criteria for the rhyming riddles to be solved by the members. For example, the leader may utilize the educational tool's user interface to enter certain keywords. The educational tool may work in conjunction with an external search engine and use its metadata to form a comprehensive list of topics that relate to the keywords entered by the leader. The comprehensive list may be narrowed to a limited list of the topics found in the database. The educational tool may form a set of rhyming riddles that concern the topics on the limited list. Rhyming riddles may be randomly selected from the set and presented to the members of the group. Alternatively, the leader may review the rhyming riddles in the set and select those rhyming riddles he or she wants the members to solve.

In some embodiments, the leader may be a parent or tutor helping a student master a particular subject. The student's learning experience (i.e., his or her interaction with the educational tool) may be tailored to supplement the instruction received in the classroom. The leader may enter keywords that result in the formation of a set of rhyming riddles that concern the subject that needs to be mastered. The student may gain knowledge about the subject as he or she solves rhyming riddles from this set. The leader may track the student's performance and assess his or her progress because their educational tools are linked. As a result, the leader may adapt the student's learning experience to meet his or her changing needs.

In other embodiments, the leader of the group may be a teacher and the members of the group may be the students in the teacher's class. The educational tools of the students may be linked to the educational tool of the teacher, but not to each other. Accordingly, the teacher may track the performance of the students, but students may not track the performance of other students. Hence, a student may not compare his or her performance to the performance of other students and become discouraged because he or she is not performing as well.

The teacher may have read-only access to the database so he or she may browse the available categories and subcategories. Consequently, the teacher may choose the source of the rhyming riddles to be solved by the class. Depending upon their source, the different rhyming riddles may concern various related topics or a single topic. The teacher may select a category to be the source of the rhyming riddles. As a result, the rhyming riddles may concern any topic in any subcategory of the category and may be appropriate if the teacher intends the collaborative learning session to be an overview of the category. Alternatively, the teacher may select a subcategory of the category to be the source of the rhyming riddles. In this case, the rhyming riddles may relate to any topic in the subcategory and may be appropriate if the teacher intends the collaborative learning session to be an overview of the subcategory. The teacher may enter keywords to further limit the topic of the rhyming riddles presented to the class. The rhyming riddles may become more and more focused as the teacher adds to the keywords entered into his or her educational tool.

For example, the teacher may teach an introductory college course in psychology. Very early in the semester, he or she may select the category 348 “Psychology” to be the source of the rhyming riddles presented to the class during collaborative learning sessions. Furthermore, the teacher may specify a level of difficulty of one or two so that the rhyming riddles are very basic and appropriate for students gaining an overview of the topics that will be studied during the semester. One such topic may be the schools of thought in the field of psychology. To introduce this topic, the teacher may select subcategory 348l “Schools of Thought” to be the source of the rhyming riddles presented to the class. In addition, the teacher may specify a level of difficulty of one or two so that the rhyming riddles are appropriate for students beginning their study of the various schools of thought in the field of psychology. The teacher may enter appropriate keywords to focus study on a particular school of thought. For example, to restrict the topic of the rhyming riddles to the humanistic school of thought, the teacher may enter keywords such as “humanistic,” “humanistic theories,” “humanistic psychology,” or the like. He or she may further limit the topic as the class delves deeper into the humanistic school of thought. The teacher may enter the keywords “Abraham Maslow” to focus the collaborative learning sessions on a pioneer in the field of humanistic psychology. He or she may input the keywords “hierarchy of needs” to emphasize one of Maslow's theories. The teacher may continue to enter keywords that progressively narrow the focus of the collaborative learning sessions depending upon the class's learning needs. Moreover, the teacher may specify a level of difficulty of three, four, or five so that the rhyming riddles are appropriate for students who have mastered the basic principles of the humanistic school of thought and progressed to more advanced concepts. Hence, collaborative learning sessions may be included in a teacher's study plan and used throughout the semester to supplement more conventional teaching methods.

The teacher may have other ways to manage the class's collaborative learning sessions. In particular, he or she may ensure that the rhyming riddles are considered and solved by the entire class at the same time. As the leader of the group, the teacher may designate a start time and a finish time for a collaborative learning session. At the designated start time, the students' educational tools may switch to an active state in which they can be used to solve rhyming riddles. At the designated finish time, the students' educational tools may return to an inactive state and remain in this state until the next designated start time. As a result, the students may use their educational tools during collaborative learning sessions, but not at other times while at school.

The teacher may track the performance of the entire class during a collaborative learning session. When needed, he or she may adjust the level of difficulty of the rhyming riddles. In an embodiment, the teacher's educational tool may display statistics indicative of the class's performance. The statistics may reveal that the class is selecting incorrect answer choices more often than it is selecting correct answers. Accordingly, the teacher may choose a lower level of difficulty for the rhyming riddles. Conversely, the statistics may reveal that the class is consistently selecting correct answers. Hence, the teacher may choose a higher level of difficulty for the rhyming riddles.

In addition, the teacher may track the performance of individual students during a collaborative learning session. The teacher's educational tool may display statistics for each student. The statistics may identify a student who is having difficulty selecting the correct answers to the rhyming riddles. The student may be assigned additional rhyming riddles selected by the teacher to improve the student's performance. The teacher may select rhyming riddles that have the same level of difficulty as the rhyming riddles presented during the collaborative learning session. However, the student may need remedial instruction. In this case, the teacher may select rhyming riddles that have a lower level of difficulty. Conversely, the statistics may identify a student who is consistently selecting the correct answer to the rhyming riddles presented during the collaborative learning session. Accordingly, the student may be assigned additional rhyming riddles that have a higher level of difficulty than the rhyming riddles presented to the remainder of the class.

In the embodiments described above, the educational tool is used for collaborative learning purposes. Alternatively, the educational tool may be configured for competitive play. A user may compete against an individual or members of a small group to determine who solves the most rhyming riddles correctly. The user may know the individual or group members. The person who initiates the competition may be designated the leader and may choose the topic and the level of difficulty for the rhyming riddles to be solved by the players. For example, in an academic setting, the teacher may be the leader and the players may be all the students in the class if the class is small or several small groups of students if the class is large. Competitive play may occur in other settings. The small group may be a family with a parent serving as the leader. A small group may form and meet regularly to engage in competitive play. The members of the group may be similar ages (e.g., young adults, middle-aged adults, and senior citizens). The small group may meet at social settings that include civic centers, clubs, and pubs. In addition, the proprietors of appropriate social settings may be encouraged to host “trivia nights” and the educational tool may be used to provide the rhyming riddles that will be answered by patrons. Regardless of the setting, the names and scores of all the players may be displayed on each player's educational tool. As a result, a player may determine his or her standing in the group.

Instead of individual players, teams may compete to determine which team solves the most rhyming riddles correctly. For example, the teams may be from different cities, states, regions, or the like. Alternatively, the teams may be composed of students from different high schools or colleges, members of different groups having similar educational goals, or the like. Each team may have an educational tool. When presented with a rhyming riddle, a team may discuss the rhyming riddle and the answer choices. After agreeing on an answer choice, the team may select that answer choice from the set of answer choices displayed on their educational tool. A team may serve as the leader for a competitive play session and choose the topic and the level of difficulty for the rhyming riddles to be considered and answered by all the teams. The names of the teams and their scores may be displayed on each team's educational tool. Hence, a team may compare its performance to the performance of the other teams.

In other embodiments, a player may compete with one to three other online players. He or she may choose the category or subcategory and the level of difficulty for the rhyming riddles to be answered during competitive play. For example, the player may select subcategory 314d “Novels” from category 314 “Fictional Characters” and a level of difficulty of three. The player's past performance may indicate that he or she chooses the correct answer 62% of the time when presented with rhyming riddles from the selected subcategory that have the selected level of difficulty. The player's educational tool may search online and identify other players who perform similarly and invite them to compete with the player. If they accept, competitive play begins. The first names of the players and their scores may be displayed on each player's educational tool while competitive play is occurring.

In yet another embodiment, a television game show may provide the setting for competitive play. The television game show may be filmed on a sound stage containing a large screen. Contestants may be individual players or teams of players (e.g., those teams discussed above) who vie for points by solving rhyming riddles displayed on the large screen. For example, there may be two contestants on the game show. The contestants may be two individual players or two teams of three to five players each. The host of the game show may announce the names of five randomly selected subcategories. Competitive play may begin when a first contestant chooses one of the subcategories and a level of difficulty. The rhyming riddle from the chosen subcategory that has the chosen level of difficulty may be displayed on the sound stage's large screen along with a set of answer choices. The screen may be large enough for the host, contestants, studio audience, and television viewing audience to read the rhyming riddle and the answer choices displayed on it. The first contestant may have a limited amount of time to contemplate the rhyming riddle and the answer choices. Once the contestant has selected an answer choice, the large screen may indicate if the selected answer choice is the correct answer. If the correct answer is selected, the contestant may be awarded a number of points depending upon the level of difficulty of the rhyming riddle. The point values may increase from a minimum for a rhyming riddle that has a level of difficulty of one to a maximum for a rhyming riddle that has a level of difficulty of five. For instance, a contestant may be rewarded 10, 20, 30, 40, or 50 points if the level of difficulty of the rhyming riddle is one, two, three, four, or five, respectively.

The first contestant may choose a subcategory and a level of difficulty for a second rhyming riddle. As long as the first contestant selects the correct answer to a rhyming riddle, he or she may choose the subcategory and the level of difficulty for the next rhyming riddle. Play may continue in this fashion until the first contestant chooses a wrong answer choice. The second contestant may be given the opportunity to solve the rhyming riddle that the first contestant answered incorrectly. If the second contestant chooses the correct answer, he or she may select a subcategory and a level of difficulty for the next rhyming riddle. The second contestant may continue to select a subcategory and a level of difficulty for subsequent rhyming riddles until he or she chooses a wrong answer choice. The first contestant may be given the opportunity to solve the rhyming riddle that the second contestant failed to answer correctly. The game may continue in this manner until the host announces that the time for play has ended. The contestant with the higher score is declared the winner.

A content manager may use an educational tool to supply the rhyming riddles that the contestants attempt to solve. In particular, the content manager may instruct the educational tool to randomly select the five subcategories that the contestants choose as they compete on the game show. The five subcategories may be selected from the subcategories listed in FIGS. 3A-3G. When a contestant chooses one of the five subcategories and a level of difficulty, the content manager may direct the educational tool to form a group of rhyming riddles from the chosen subcategory that have the chosen level of difficulty. A rhyming riddle may be randomly selected from the group and displayed on the large screen. The correct answer may be displayed along with several incorrect answer choices selected by the educational tool. The incorrect answer choices may be selected by the educational tool because of their similarity to the correct answer. When a contestant chooses an answer choice, the content manager may use the educational tool to determine if the selected answer choice is the correct answer. If the correct answer is chosen, the large screen may display celebratory images (e.g., fireworks). Conversely, the large screen may display disconsolate images (e.g., sad faces) when an incorrect answer choice is selected.

Alternatively, the television game show may be a series of rounds. During the first round, the rhyming riddles may have a level of difficulty of one. Each rhyming riddle may be randomly selected from any of the subcategories listed in FIGS. 3A-3G. The first round may begin when the large screen displays a first rhyming riddle. The first contestant may select an answer choice from the set of answer choices also displayed on the large screen. A second rhyming riddle may be displayed if the first contestant answers the first rhyming riddle correctly. If an incorrect answer choice is selected, the large screen may indicate the correct answer before the first rhyming riddle is replaced by the second rhyming riddle. The first contestant may be allocated a certain amount of time to answer as many rhyming riddles as possible. In a similar fashion, the second contestant may be allowed to answer rhyming riddles during the first round. If the contestants are two teams, the members of the first team and then the second team may take turns answering the rhyming riddles that appear on the large screen. The contestants receive a point for each rhyming riddle answered correctly.

During the second round, the rhyming riddles may have a level of difficulty of two. The second round may proceed similarly to the first round of the game. However, the contestants may have a longer amount of time to answer the rhyming riddles displayed on the large screen because the rhyming riddles are more difficult to solve during the second round. With each successive round, the level of difficulty may be increased by one and the contestants may be given more time to answer the rhyming riddles presented sequentially on the large screen. There may be a total of five rounds. During the fifth round, the rhyming riddles may have a level of difficulty of five. Accordingly, the contestants may have the longest amount of time to answer the rhyming riddles that appear on the large screen. The winner may be the contestant who has accumulated more points during the five rounds of play.

The content manager may use the educational tool to facilitate play during the five rounds. During each round, the content manager may instruct the educational tool to randomly select rhyming riddles that have the appropriate level of difficulty. The educational tool may be directed to display a rhyming riddle on the large screen. A set of answer choices may be displayed along with the rhyming riddle. The set of answer choices may include the correct answer and several incorrect answer choices chosen by the educational tool because they are similar to the correct answer. When a contestant selects an answer choice, the content manager may use the educational tool to determine if the answer choice is the correct answer to the rhyming riddle. If the contestant chooses the correct answer, the content manager may instruct the educational tool to display another rhyming riddle on the large screen. However, if the contestant selects an incorrect answer choice, the educational tool may indicate the correct answer on the large screen before displaying another rhyming riddle.

The television game show is another format that may use the educational tool to promote learning. The contestants may learn about the topics of the rhyming riddles they solve. The host, studio audience, and television viewing audience may also acquire knowledge as they read a rhyming riddle displayed on the large screen and see which answer choice is the correct answer. Ideally, the host and members of the studio and television viewing audiences may become more immersed in the learning process by selecting an answer choice after reading the rhyming riddle and comparing their answer choice to the correct answer once it is revealed on the large screen. By taking a more active role in the learning process, the host and audience members may be more likely to retain the factual information contained in the rhyming riddles they attempt to solve. Even the content manager may benefit from the role he or she plays in making the competitive play possible. The content manager may gain knowledge as he or she reviews the rhyming riddles and their correct answers before displaying them on the large screen.

The learning experience may not end with the television game show. Instead, it may serve as the starting point for those viewers intrigued by the subject matter of the rhyming riddles presented during the airing of an installment of the show. After airing of the installment has concluded, a viewer may visit a website that elaborates on the subject matter of the rhyming riddles. The website may provide links to other sites that provide additional information. The viewer may customize his or her interaction with the website by learning about the subject matter of those questions of particular interest to him or her. Furthermore, the viewer may choose the amount of material to consider commensurate with the extent of his or her existing knowledge. If the viewer knows very little about the subject matter of a rhyming riddle, he or she may contemplate most, if not all, of the information available on the website and linked sites. Conversely, if the viewer is already well-informed, he or she may ponder only the information that adds to his or her existing knowledge base. Alternatively, the well-informed viewer may peruse more information to reinforce what he or she already knows. Hence, a viewer may continue to learn in a manner most consistent with his or her learning objectives after the airing of an installment of the game show has ended.

The educational tool may be utilized individually, collaboratively, or competitively. Regardless of the type of use, the educational tool may impart knowledge about various topics from the categories and subcategories listed in FIGS. 3A-3G. There may be additional ways the educational tool fosters learning. A user may be regularly encouraged to write rhyming riddles about a topic of interest to him or her. The process of composing a rhyming riddle may add to the user's knowledge of the topic. The user may conduct research to determine the details he or she will include in the rhyming riddle. The details may be reviewed numerous times as the user works to put them in the rhyming riddle format. Hence, the user may learn about the topic of the rhyming riddle he or she composes.

The user may determine the level of difficulty for his or her rhyming riddle before submitting it to the database administrator. He or she may consult guidelines for determining level of difficulty and learn that rhyming riddles with a level of difficulty of one may be appropriate for good high school students; rhyming riddles with a level of difficulty of two may be appropriate for high school graduates who paid attention in class; rhyming riddles with a level of difficulty of three may be appropriate for college graduates; rhyming riddles with a level of difficulty of four may be appropriate for graduate students; and rhyming riddles with a level of difficulty of five may be appropriate for specialists in a given field. The user may establish the level of formal education needed to understand his or her rhyming riddle and determine the corresponding level of difficulty. For example, the user may decide that college graduates are most likely to select the correct answer to his or her rhyming riddle. Accordingly, he or she may determine that a level of difficulty of three is appropriate.

The determination of the level of difficulty is subjective and may be influenced by creator bias. Once a rhyming riddle has been submitted to the database administrator, a reviewer may adjust the user-assigned level of difficulty to correct for the user's insufficient objectivity. The user may be encouraged to monitor the changes made to the levels of difficulty he or she assigns to his or her rhyming riddles. Over time, as the user submits more rhyming riddles, he or she may realize that the reviewer typically adjusts the level of difficulty by a certain offset amount. As a result, the user's determination of the level of difficulty may become a two-step process. First, the user may select a level of difficulty using the same method he or she has always used. The result is a preliminary level of difficulty. Second, the user may adjust the preliminary level of difficulty by the offset amount to obtain the final level of difficulty. For example, the user may determine that the preliminary level of difficulty is equal to four by applying the method he or she has always used. The reviewer may typically decrease the user-assigned level of difficulty by one. Hence, the user may subtract one from the preliminary level of difficulty of four to obtain a final level of difficulty of three. The second step may mitigate the effect of subjectivity and creator bias on the determination of level of difficulty.

The database administrator may have assigned the user's rhyming riddles to the reviewer who consistently adjusted the level of difficulty. The reviewer may have been selected from a group of reviewers. Each reviewer in the group may have a particular area of expertise. Reviewers may be teachers of certain subjects, members of specific professions, and graduate students pursuing advanced degrees in relevant academic disciplines. In addition, reviewers may be avid users of the educational tool and experienced contributors to the database.

A user's riddle may be assigned to a reviewer whose area of expertise includes the topic of the riddle. The reviewer may determine if the riddle is in the rhyming format. In addition, the reviewer may check the facts included in the riddle to confirm that they are accurate. Then, the reviewer decides if the rhyming riddle should be added to the database. The reviewer's decision is only preliminary. The database administrator may make the final decision. If the database administrator concurs with the reviewer, the user's rhyming riddle may be added to the database. If the database administrator and the reviewer do not agree, the rhyming riddle may not be added to the database in accordance with the database administrator's final decision. The database administrator may have other responsibilities in addition to assigning riddles to appropriate reviewers and evaluating the rectitude of their preliminary decisions regarding the addition of the riddles to the database. For example, he or she may monitor and assess the performance of all the reviewers to ensure that their fact-checking is accurate and their decision-making is objective. The database administrator may be a former reviewer selected from the group because of his or her superlative performance.

As discussed above, the educational tool may be used individually, collaboratively, or competitively. Several benefits may result from use of the educational tool regardless of the manner in which it is utilized. For example, the consideration of rhyming riddles may improve problem-solving skills for at least four reasons. First, the solution of rhyming riddles involves both the logical left hemisphere and the creative right hemisphere of the brain. Like all problems, as more rhyming riddles are solved, the two hemispheres become more proficient at working together which results in a more creative and flexible approach to solving problems. Second, rhyming riddles stimulate primitive neural pathways in a user's brain, as do all problems, riddles, and puzzles. These pathways are associated with an innate problem-solving ability. With continued use of the educational tool, the primitive pathways become more involved and experienced in the problem-solving process. Third, several different brain functions become more efficacious when used to solve rhyming riddles. Recall, association, trial and error, formulation and testing of ideas, and recombination of thoughts are all brain functions that become more effective when rhyming riddles are solved on a regular basis. Fourth, the consideration of rhyming riddles may improve lateral thinking. This type of thinking is an unorthodox approach to problem solving in that it considers several possibilities from different perspectives to arrive at a solution. Thinking of this type is creative, “out of the box,” imaginative, and abstract and explores what is unknown to the user. When rhyming riddles are solved, the use of lateral thinking is reinforced and it becomes a more frequently utilized problem-solving skill. Furthermore, as lateral thinking becomes ingrained, the user becomes a more resourceful and inspired problem solver. For at least the four reasons discussed above, users of the educational tool may become adept problem solvers.

Furthermore, improvements in problem solving may be self-perpetuating. A person may experience mild anxiety when he or she encounters a problem that needs to be solved. This response to the unsolved problem is regulated by the hippocampus, a part of the limbic system. The mild anxiety is alleviated by solving the problem. It is an accepted fact that the solution of a rhyming riddle, a type of problem, causes the mesolimbic pathway to release dopamine into the nucleus accumbens, the brain's reward center. The rush of dopamine is the person's immediate reward for solving the rhyming riddle. Dopamine has a profound effect on a person. Its release results in feelings of satisfaction and accomplishment. It helps a person concentrate and feel calm, confident, optimistic, and capable. In addition, the surge of dopamine relieves stress, improves mood, and causes feelings of peace, happiness, and serenity. It is contended that a user of the educational tool would want to relive the feel-good experience that follows the release of dopamine, so he or she uses the educational tool to solve more rhyming riddles. Once again, the user is rewarded with positive feelings. As the cycle repeats itself, the user solves an ever-increasing number of rhyming riddles and may become an even more adept problem solver.

In addition, the solution of rhyming riddles may improve overall brain function. For example, solving a rhyming riddle reinforces the use of existing connections between brain cells and forms new connections. As a result, short term memory may be improved. Furthermore, the contemplation of a rhyming riddle stimulates countless neural connections which trigger and promote utilization of a user's recall and reasoning abilities. Also, problem solving results in the increased production of myelin, the substance that surrounds the axon of a brain cell. The function of an axon is to transmit information between brain cells. Myelin increases the rate at which information is transmitted and is essential to effective cognition. Hence, the advantages gained by using the educational tool are not limited to the learning of factual information. Overall cognitive function may be improved as well.

Furthermore, use of the educational tool may exercise the brain. When a user contemplates a rhyming riddle, the brain has to consider new ideas, make connections, think, learn facts, analyze, recall information, associate, deduce, resolve dilemmas, and make decisions. These mental activities exercise the brain and keep it healthy. Regular exercise maintains or even improves brain function. The solution of rhyming riddles may be an interesting and enjoyable way to get the exercise that is essential to the brain's health.

In addition, the brain requires regular exercise to maintain its agility. Rhyming riddles are mental stressors that activate normally dormant areas of the brain. The stimulation of these areas forces the brain to change the way it works. New brain cells are formed and connect to existing neural pathways. As a result, new pathways are created. Newly formed pathways are fragile and require repeated exercise to support default ways of thinking. The solution of rhyming riddles may provide the exercise required to change the brain's neural circuitry and preserve its agility.

Repeated use of the educational tool may also have a positive impact on memory. As discussed above, the rhyming riddle format stimulates primitive neural pathways in the brain. In addition to problem solving, these pathways are associated with the retention and recall of information. Continued utilization of the educational tool may reinforce the use of the primitive pathways. As a result, memory may be improved. The solution of rhyming riddles may help all age groups. However, senior citizens may benefit the most because frequent use of the educational tool may mitigate the effects of memory deterioration and dementia.

FIGS. 4A-4P are screenshots of an embodiment of the educational tool. In this embodiment, the user may be presented with a rhyming riddle that includes factual information about a famous deceased person. The user may learn about the famous deceased person as he or she attempts to solve the rhyming riddle. This embodiment is entitled “Epitaddles,” a term coined by combining the words “epitaph” and “riddles.” Like most embodiments of the educational tool, “Epitaddles” allows the user to solve rhyming riddles in one of three modes (individual, collaborative, or competitive). Furthermore, its use may benefit the user's brain in the ways discussed above.

When the user selects the “Epitaddles” embodiment, he or she chooses a level of difficulty and the software application searches subcategory 312a “Deceased” in category 312 “Famous People” and forms a group that contains rhyming riddles that have the chosen level of difficulty. A rhyming riddle is eliminated from the group if it is one of the previous 100 rhyming riddles attempted by the user. The software application randomly selects a rhyming riddle from the rhyming riddles that remain.

FIG. 4A depicts one screen of a multi-screen user interface utilized in the “Epitaddles” embodiment. Other screens of the interface are illustrated in FIGS. 4B-4P. The screens shown in the figures will include additional elements when they are displayed on a user's desktop computer, portable electronic device, or other electronic device. The additional elements will make the screens more aesthetically pleasing and engaging.

FIG. 4A depicts the screen that appears once the “Epitaddles” embodiment and a first level of difficulty have been chosen and the software application has randomly selected a first rhyming riddle. The screen shows a headstone 402, but the first rhyming riddle 404 replaces the epitaph. The first rhyming riddle 404 provides factual information about a famous deceased person. A first circle 406 adjacent to the headstone 402 indicates that the first rhyming riddle 404 has a first level of difficulty equal to four.

FIG. 4B depicts the screen that asks the user to identify the famous deceased person who is the topic of the first rhyming riddle 404. A question 408 “Do you know who lies below?” (or similar challenge) and a first set of answer choices 410-416 replace the first rhyming riddle 404 on the headstone 402. One of the answer choices 410-416 is the correct answer to the first rhyming riddle 404. The three incorrect answer choices are randomly selected from a group of answer choices that have similar characteristics to the correct answer. Accordingly, all four answer choices 410-416 are famous Russian composers who lived during the 19th and 20th centuries.

The user may not know which answer choice is the correct answer. If the user does not want to guess, he or she may choose one of two options. First, the user may select a button which reads “Give Answer” (not shown). If this button is selected, the user may learn the identity of the famous deceased person but does not gain or lose any points. Second, the user may select a button which reads “Next” or “Move On” (not shown). If the user selects this button, he or she forfeits an opportunity to learn about the famous deceased person. The software application may randomly select a rhyming riddle about another famous deceased person and present it to the user.

Alternatively, the user may think he or she knows the correct answer and may select the corresponding answer choice. If the user selects the correct answer, he or she may be awarded a number of points equal to the rhyming riddle's level of difficulty. However, if the user chooses an incorrect answer choice, the software application may display another rhyming riddle that concerns the same famous deceased person. The set of answer choices may contain the same choices minus the incorrect answer choice selected by the user. The newly presented rhyming riddle may include additional information about the famous deceased person. However, its level of difficulty may be one less than the level of difficulty for the previous rhyming riddle. Hence, the number of points that may be awarded to the user is reduced by one. If the user selects another incorrect answer choice, the software application may display yet another rhyming riddle about the same famous deceased person. This process may be repeated until the user selects the correct answer or has selected all of the incorrect answer choices and only the correct answer remains. In other words, the user may be given a number of opportunities to select the correct answer. The number of opportunities may be equal to the original number of answer choices minus one. As indicated in FIG. 4B, the initial set of answer choices contains four choices 410-416. Accordingly, the user has three opportunities to select the correct answer.

FIG. 4C depicts the screen that allows the user to select a first answer choice. A radio button precedes each of the answer choices 410-416. The user selects the first answer choice by selecting the corresponding radio button. In FIG. 4C, the user has selected the radio button 418 that precedes answer choice 416 “Alexander Borodin.” The user has used the first of three opportunities to select the correct answer to the first rhyming riddle 404.

FIG. 4D depicts the screen that reveals if the user has selected the correct answer. A large check mark preceding the selected answer choice signifies that the answer choice is the correct answer, whereas a large “X” preceding the selected answer choice signifies that the answer choice is an incorrect answer. In FIG. 4D, the large “X” 420 indicates that the answer choice 416 “Alexander Borodin” is not the correct answer to the first rhyming riddle 404. The correct answer is not revealed at this juncture. Instead, the first level of difficulty of four is reduced by one to obtain a second level of difficulty equal to three and a first number of remaining points also equal to three. Because the first number of remaining points is not equal to zero, the user is given a second opportunity to select the correct answer.

FIG. 4E depicts the screen that displays a second rhyming riddle 422 that has the same answer as the first rhyming riddle 404. The screen shows the headstone 402, but the second rhyming riddle 422 replaces the epitaph. The second circle 424 indicates that the second rhyming riddle 422 has the second level of difficulty which is equal to three.

FIG. 4F depicts the screen that poses the question 408 for the second time and provides a second set of answer choices 410-414. The question 408 “Do you know who lies below?” and the second set of answer choices 410-414 replace the second rhyming riddle 422 on the headstone 402. The first answer choice 416 “Alexander Borodin” is no longer visible because it was identified as an incorrect answer in FIG. 4D. The reduced number of answer choices shown in FIG. 4F and the lower level of difficulty shown in FIG. 4E make the second rhyming riddle 422 easier to solve than the first rhyming riddle 404.

FIG. 4G depicts the screen that allows the user to select a second answer choice from the second set of answer choices 410-414. The user has selected the radio button 426 that precedes the answer choice 412 “Dimitri Shostakovich.” This selection indicates that the user has decided that “Dimitri Shostakovich” is the correct answer to the second rhyming riddle 422 and the first rhyming riddle 404. The user has used the second of three opportunities to select the correct answer.

FIG. 4H depicts the screen that indicates if the user has selected the correct answer. The large “X” 428 signifies that the second answer choice 412 “Dimitri Shostakovich” is not the correct answer to the second rhyming riddle 422 and the first rhyming riddle 404. The correct answer may not be revealed at this juncture. Instead, the second level of difficulty of three is reduced by one to obtain a third level of difficulty equal to two and a second number of remaining points also equal to two. Because the second number of remaining points is not equal to zero, the user is given a third opportunity to select the correct answer.

FIG. 4I depicts the screen that displays a third rhyming riddle 430 that has the same answer as the first rhyming riddle 404 and the second rhyming riddle 422. The screen shows the headstone 402, but the third rhyming riddle 430 replaces the epitaph. The third circle 432 indicates that the third rhyming riddle 430 has the third level of difficulty which is equal to two.

FIG. 4J depicts the screen that asks question 408 for the third time and provides a third set of answer choices 410 and 414. The question 408 “Do you know who lies below?” and the third set of answer choices 410 and 414 replace the third rhyming riddle 430 on the headstone 402. The answer choice 412 “Dimitri Shostakovich” is no longer visible because it was identified as an incorrect answer in FIG. 4H. In addition, the answer choice 416 “Alexander Borodin” may remain unavailable as an answer choice. The reduced number of answer choices shown in FIG. 4J and the lower level of difficulty shown in FIG. 4I make the third rhyming riddle 430 easier to solve than the second rhyming riddle 422.

FIG. 4K depicts the screen that allows the user to select a third answer choice from the third set of answer choices 410 and 414. The user has selected the radio button 434 that precedes answer choice 414 “Pyotr Tchaikovsky.” This selection indicates that the user has decided that “Pyotr Tchaikovsky” is the correct answer to the third rhyming riddle 430, the second rhyming riddle 422, and the first rhyming riddle 404. The user of the educational tool has used the third of three opportunities to select the correct answer.

FIG. 4L depicts the screen that indicates if the user has selected the correct answer. The large check mark 436 signifies that the answer choice 414 “Pyotr Tchaikovsky” is the correct answer to the third rhyming riddle 430, the second rhyming riddle 422, and the first rhyming riddle 404. The third level of difficulty is added to the user's score because the correct answer was selected. As shown in FIG. 4I, the third level of difficulty is equal to two. Accordingly, the user's score is increased by two points.

FIG. 4M depicts the screen that appears once the correct answer has been selected by the user. The headstone 402 displays information 438 about the famous deceased person who is the correct answer to the rhyming riddles. The information 438 includes the name of the famous deceased person, his or her years of life, and the reason for his or her fame. In the present example, the name “Pyotr Tchaikovsky” is displayed on the headstone 402. The years “1840-1893” appear beneath Tchaikovsky's name. Below the years of his life, Tchaikovsky is identified as a “Russian Romantic Composer.” As such, he achieved fame and ranks among famous deceased people.

Two buttons appear at the base of the headstone 402 shown in FIG. 4M. To the left is a first button 440 which reads “See Short Biography.” To the right is a second button 442 which reads “Play Another Epitaddle.” If neither button is selected, the screen displays a portrait or photograph of the famous deceased person above his or her name. In FIG. 4N, the information 438 on the headstone 402 has been replaced by a portrait 444 of Pyotr Tchaikovsky. His name 446 is visible beneath the portrait 444. The first button 440 and the second button 442 are still visible at the base of the headstone 402.

FIGS. 4O and 4P depict the two screens that are displayed if the user selects the first button 440 which reads “See Short Biography.” Arrow 448 indicates that the first button 440 has been selected. The headstone 402 is replaced by the box 450 shown in FIG. 4O and the box 452 shown in FIG. 4P. The boxes 450 and 452 contain a short biography of Tchaikovsky's life. The short biography explains the factual information presented in the first rhyming riddle 404, the second rhyming riddle 422, and the third rhyming riddle 430. Additional information about Tchaikovsky's life is presented. The user may know more about the famous composer Pyotr Tchaikovsky after pondering the three rhyming riddles and reading his short biography. The user may select the second button 442 which reads “Play Another Epitaddle” once he or she is finished learning about Tchaikovsky.

The user may learn about Tchaikovsky's life even if he or she had selected answer choice 410 “Modest Mussorgsky” from the screen shown in FIG. 4K. Instead of the large check mark 436 preceding answer choice 414 “Pyotr Tchaikovsky,” the screen shown in FIG. 4L would have displayed a large “X” in front of answer choice 410 “Modest Mussorgsky.” The screen showing the large “X” would have been followed by the screen shown in FIG. 4M which provides information 438 about the correct answer choice 414 “Pyotr Tchaikovsky.” The user could select the first button 440 which reads “See Short Biography” and the short biography of Tchaikovsky would have materialized as shown in FIGS. 4O and 4P. Hence, the outcome would have been the same had the user selected the incorrect answer choice 410 “Modest Mussorgsky” instead of the correct answer choice 414 “Pyotr Tchaikovsky” from the screen shown in FIG. 4K.

The user may select the second button 442 which reads “Play Another Epitaddle” when he or she is ready to solve another rhyming riddle about a famous deceased person. When the second button 442 is selected as indicated by arrow 454, the software application searches subcategory 312a “Deceased” in category 312 “Famous People” and forms a group that contains rhyming riddles that have the first level of difficulty. Rhyming riddles are eliminated from the group if they are among the previous 100 rhyming riddles attempted by the user. The software application randomly selects a rhyming riddle from the rhyming riddles that remain.

The user may alter the embodiment shown in FIGS. 4A-4P by selecting options other than those shown. For example, the user may select “research mode.” This mode may be invoked when the user has failed to select the correct answer to the first rhyming riddle and the second rhyming riddle and cannot determine the correct answer when presented with the third rhyming riddle. Using the search engine or website of his or her choice, the user may search for a limited number of keywords taken from the rhyming riddles. If this search does not identify the correct answer, the user may search for the answer choices. The results of either search may include a biography of the famous deceased person who is the correct answer to the three rhyming riddles. The user may read the biography, verify that the biography was read, return to the user interface, select the correct answer, and gain the remaining points. The research mode offers several advantages. In particular, the online search allows the user to supplement the factual information about the famous deceased person included in the three rhyming riddles. The educational gain is more important than the benefit conferred to the user by allowing him or her to conduct research before selecting a final answer choice.

Several options may be available to the user who reads the short biography and wants to learn more about the famous deceased person. For example, a first button that reads “Another Epitaddle About the Same Person” and a second button that reads “Search Online” may appear at the end of the short biography. These buttons may be alternatives to the button that reads “Play Another Epitaddle.” The user may select this last button when he or she wants to attempt to solve a rhyming riddle about a different famous deceased person, whereas the user may select the first button when he or she wants to attempt to solve another rhyming riddle about the same famous deceased person. If selected, the second button may allow the user to conduct an online search for information that supplements the facts presented in the rhyming riddles and the short biography. The option invoked by selecting the second button is not to be confused with the research mode. The second button may be selected after the correct answer to the rhyming riddles is known, whereas the research mode may be selected while the user is still trying to determine the correct answer.

Another option may allow the user to learn about lesser-known deceased people. If this option is selected, the software application may randomly select a rhyming riddle from subcategory 312c “Lesser-Known Deceased” in the category 312 “Famous People.” The subjects of the rhyming riddles in this subcategory are noteworthy people who are not as widely known as the people in subcategory 312a “Deceased.” Examples of lesser-known deceased people include Michael Balcon (1896-1977), a British film producer known for his guidance of young Alfred Hitchcock; Willard Frank Libby (1908-1980), an American physical chemist who was awarded the 1960 Noble Prize in Chemistry for his role in the development of radiocarbon dating; J. Arthur Rank (1888-1972), a British industrialist who was the founder and head of the Rank Organisation (an entertainment conglomerate); Wilhelm Röntgen (1845-1923), a German physicist who was awarded the 1901 Noble Prize in Physics for his discovery of X-rays; and Ella Wheeler Wilcox (1850-1919), an American poet whose poem ‘Solitude’ includes the oft-quoted lines “Laugh, and the world laughs with you; Weep, and you weep alone.” All of the rhyming riddles in subcategory 312c may have a level of difficulty of five.

There may be additional ways “Epitaddles” promotes learning about famous deceased people and lesser-known deceased people. For example, the user may be frequently encouraged to write a rhyming riddle about a deceased person who interests him or her. If the user decides to compose a rhyming riddle, he or she may conduct research to determine which details will be included in the rhyming riddle. The details may be reviewed numerous times as the user puts them in the rhyming riddle format. Hence, the user may gain knowledge about the subject of the rhyming riddle he or she composes.

Furthermore, a user may submit a rhyming riddle that is a personal tribute. A rhyming riddle of this type may concern any deceased person the user wants to honor. The subject of the rhyming riddle may be someone the user knew, such as a respected relative, friend, neighbor, teacher, coach, boss, or the like. Alternatively, the rhyming riddle may relate to someone the user did not know personally, but admired nonetheless. The subjects of these rhyming riddles may include a well-regarded local leader, business person, author, artist, inventor, or the like. The user may compose a rhyming riddle that is a personal tribute because he or she wants to share the life of a notable person with other users of the educational tool. Accordingly, the user may submit the rhyming riddle to the database administrator along with a short biography of the deceased person who is the subject of the rhyming riddle. The database administrator may add the rhyming riddle to a special category in the database. The special category may contain nothing but rhyming riddles that are personal tributes. In addition, the special category may not be searched by the software application. To view the rhyming riddle, another user has to select the special category and then choose that particular rhyming riddle. The other user may choose the rhyming riddle because he or she wants to learn about a remarkable person for his or her own edification. All rhyming riddles that are personal tributes may have a level of difficulty of five.

When presented to other users, this type of rhyming riddle is not followed by a set of answer choices. Instead, it may be followed by the short biography of the deceased person submitted by the user. The short biography may explain the factual information included in the rhyming riddle and emphasize the admirable qualities of the deceased person. The software application may display a true or false question after another user has had enough time to review the short biography. The other user may earn one point if he or she answers the question correctly. The easily-earned point may entice other users to learn about deceased people who are not well known by the general public, but noteworthy nonetheless.

In most of the embodiments described above, the educational tool enables a user to choose a category or subcategory and a level of difficulty. The educational tool accesses the database that stores rhyming riddles created by a plurality of users and requests the database to randomly select a rhyming riddle that concerns a topic in the chosen category or subcategory and has the chosen level of difficulty. Instead of a user interacting with the educational tool, a database administrator may utilize the tool in much the same way as the user. However, the database administrator may print a rhyming riddle for the user to solve. The printed rhyming riddle is intended to improve the problem-solving skills of the user. In this respect, the printed rhyming riddle is no different than a rhyming riddle displayed on a screen.

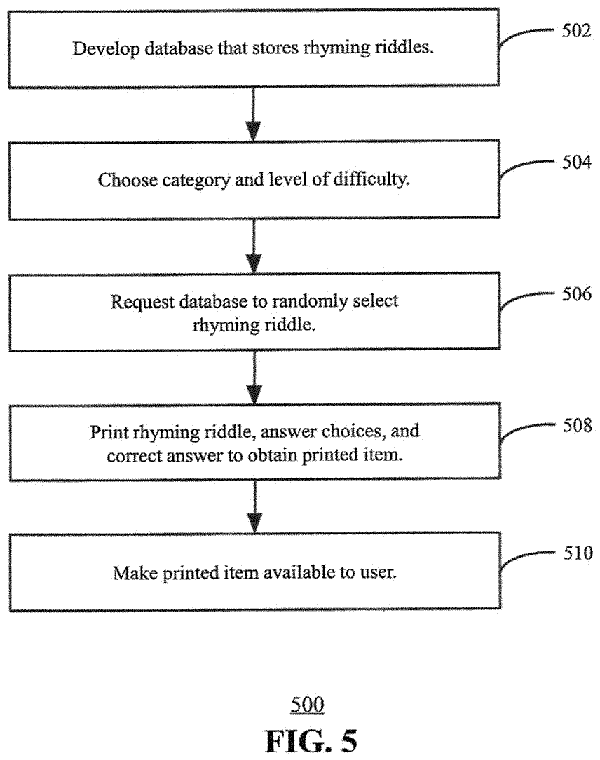

FIG. 5 is a process flow diagram of a method for providing a user with a rhyming riddle in a printed format. The present embodiment may utilize the same database and software application used in the embodiments discussed above. The method 500 may include blocks 502-510.

At block 502, a database administrator may develop a database that stores rhyming riddles created by a plurality of contributors. In this respect, the present embodiment is the same as the embodiments described above. At block 504, the database administrator may use the educational tool to choose a category or subcategory and a level of difficulty for a rhyming riddle. Any category or subcategory listed in FIGS. 3A-3G may be chosen. As discussed above, all of the categories and subcategories may fall into the general categories of people, works, happenings, places, and principles. Furthermore, the content of each general category is the same as described for previous embodiments. The level of difficulty may be an integer that has a minimum value of one and a maximum value of five. The rhyming riddles may become more difficult to solve as the level of difficulty increases. The discussion of the levels of difficulty presented above applies to the present embodiment as well.

At block 506, the database administrator may use the educational tool to request the database to randomly select a rhyming riddle that concerns a topic in the chosen category or subcategory and has the chosen level of difficulty. The entire database may be searched for rhyming riddles that concern the topic in the category or subcategory chosen at block 504 and that have the level of difficulty also chosen block 504. The rhyming riddles that meet these criteria may be formed into a group. From this group, a rhyming riddle may be randomly selected.

At block 508, the rhyming riddle, a set of answer choices, and the correct answer may be printed to obtain a printed item. The set of answer choices may include four choices. One choice may be the correct answer to the rhyming riddle and the remaining choices may be incorrect answers very similar to the correct answer. The printed item may include a brief explanation that clarifies the factual information presented in the rhyming riddle and provides additional information about the correct answer. For example, the brief explanation may be a short biography if the topic of the rhyming riddle is a famous deceased person.

At block 510, the printed item is made available to a user in a format selected from a variety of formats. For example, the chosen format may be a “scratch-off” card. The rhyming riddle and the set of answer choices may be shown on one side. Each answer choice may be scratched off to reveal if it is the correct answer. A brief explanation of the correct answer may appear on the reverse side. A user may obtain a scratch-off card when he or she makes a purchase at a fast-food establishment, a convenience store, a grocery store, or the like.

In another embodiment, the printed item may be a color-coded card. The rhyming riddle and the set of answer choices may appear on one side of the card and the correct answer may be printed on the reverse side. Once the user has selected one of the answer choices, he or she may turn the card over to compare his or her answer choice to the correct answer. A brief explanation of the correct answer may also appear on the reverse side. The card may be color-coded to indicate the general category of the rhyming riddle printed on the front. For example, a card may have a border that is one of five colors. Each color may correspond to one of the five general categories.

Cards may be available individually or in sets. Individual cards may be packaged with a cookie and the package may be sold at fast-food establishments, convenience stores, grocery stores, or the like. Furthermore, a card may be included in a packet that contains an after-dinner mint. The packets may be purchased by restaurants and distributed to their patrons. Individual users may purchase the packets and use them at dinner parties they host. As an alternative, the rhyming riddle, the set of answer choices, and the correct answer may be printed on the mint's wrapper.

A set of cards may be added to a package of gum. This format may be especially appealing to younger users. Hence, the rhyming riddles may be chosen from age-appropriate subcategories such as 310a “Entertainment—Celebrities,” 310e “Entertainment—Film,” 310f “Entertainment—Music,” and 310o “Leisure—Video Games” included in category 310 “Entertainment and Leisure;” 314a “Comic Books and Cartoons,” 314b “Movies,” and 314f “Video Games” included in category 314 “Fictional Characters;” 340k “Genre—Rock” included in category 340 “Music;” or the like. For younger sports enthusiasts, the rhyming riddles may be selected from subcategories such as 356b “Baseball,” 356c “Basketball,” 356j “Football,” 356q “Professional Teams,” 356u “Skateboarding,” or the like included in category 356 “Sports.” In addition, the level of difficulty for the rhyming riddles may vary. Rhyming riddles with a level of difficulty of four or five may be suitable for inclusion in packages of gum because younger users are often very knowledgeable about topics in the listed subcategories.

Younger users may consider the cards suitable for collecting and trading. For example, a first younger user may purchase a package of gum that includes a first card he or she already has in his or her collection. The first younger user may decide to trade the first card. A second younger user may have a second card that is a duplicate of a card he or she already owns. The second younger user may decide to trade the second card. The first younger user may not have the second card and the second younger user may not have the first card. The first and second younger users may trade cards. As a result of the trade, the first younger user may acquire the second card and the second younger user may acquire the first card. Hence, each of the younger users may procure a card that includes a rhyming riddle he or she has not previously encountered. The trading of cards combined with the continuing purchase of packages of gum may result in a younger user solving an ever-increasing number of rhyming riddles.

In addition, cards may be purchased in a boxed set. Five boxed sets may be sold separately. Each set may contain cards that include rhyming riddles from one of the five general categories. For example, one boxed set may contain cards that include rhyming riddles from the general category “People.” The box may be divided into five sections, one section for each level of difficulty. Hence, a first section may contain cards imprinted with rhyming riddles that have a level of difficulty of one; a second section may contain cards imprinted with rhyming riddles that have a level of difficulty of two; and so on.

A boxed set of cards may form the basis of a game that may be played by families and other small groups. In one embodiment of the game, a player may select a card from any section of the box. For example, the box may contain cards that include rhyming riddles from the general category “Happenings.” The player may assess the extent of his or her knowledge about happenings, decide that he or she can answer rhyming riddles having a level of difficulty of four, and select a card from the fourth section of the box. He or she may read the rhyming riddle and the answer choices printed on the front of the card and choose one of the answer choices. If the player selects the correct answer, he or she may add four points to his or her score. The number of points awarded may be equal to the level of difficulty of the rhyming riddle. Each of the other players may take his or her turn by selecting a card from any section of the box. Play may continue until a player attains a total score that equals or exceeds a specified number of points. That player wins the game. Alternatively, play may end once a prearranged amount of time has elapsed. The player with the highest total score is the winner.

In the second embodiment of the game, the players may agree to solve rhyming riddles that have the same level of difficulty. Accordingly, all players may choose cards from the same section of the box. For example, the players may opt to solve rhyming riddles that have a level of difficulty of three. When it is his or her turn, a player may select a card from the third section of the box. He or she may read the rhyming riddle and the answer choices printed on the front of the card and choose one of the answer choices. If the player selects the correct answer, he or she may add one point to his or her score. In all other respects, the second embodiment may be similar to the first embodiment of the game.

Furthermore, the boxed sets of cards may be used in a board game. The board may be sold separately. A player may purchase the board after he or she has acquired all five boxed sets of cards. Alternatively, the board and the five boxes of cards may be packaged and sold together. In this embodiment, a player may move a token around the board. He or she may roll a pair of dice to determine the number of spaces he or she may advance his or her token. The player's token may land on a space that contains instructions. The player may be instructed to solve a rhyming riddle from one of the general categories that has a certain level of difficulty. For example, the player may be required to solve a rhyming riddle from the general category “Places” that has a level of difficulty of two. He or she may select a card from the second section of the box that contains cards imprinted with rhyming riddles that concern places. The player may read the rhyming riddle and the answer choices printed on the front of the card and choose one of the answer choices. If the player selects the correct answer, he or she may roll the dice and move his or her token the appropriate number of spaces. The player's turn may continue until he or she selects an incorrect answer choice. The game may proceed as the other players take their turns.

Play may continue until a player advances his or her token to the space labeled “Finish” and solves a rhyming riddle. The general category of the rhyming riddle may be determined by a roll of one of the dice. For example, if the player rolls a one, the general category may be “People.” If the player rolls a two, the general category may be “Works.” If the player rolls a three, four, or five, the general category may be “Happenings,” “Places,” or “Principles,” respectively. If the player rolls a six, he or she may choose the general category. Likewise, the level of difficulty of the rhyming riddle may be determined by a roll of a die. If the player rolls a one, the level of difficulty may be equal to one; if the player rolls a two, the level of difficulty may be equal to two; and so on. If the player rolls a six, he or she may choose the level of difficulty for the rhyming riddle. The player selects a card from the appropriate section of the box containing cards imprinted with rhyming riddles that concern the appropriate general category. The player may win the game if he or she selects the correct answer to the rhyming riddle printed on the card. However, if the player selects an incorrect answer choice, he or she may remain on the space labeled “Finish” until he or she selects the correct answer to a rhyming riddle during a subsequent turn. In the interim, another player may reach the “Finish” space and solve a rhyming riddle. That player wins the game. The winner is the first player to advance to the “Finish” space and select the correct answer to a rhyming riddle.

In yet another embodiment, the printed item may be a newspaper. A rhyming riddle and a set of answer choices may be printed on one page of a newspaper and the correct answer and a brief explanation may be printed on a subsequent page. Rhyming riddles may be published in national, metropolitan area, larger city, smaller city, or county newspapers. The frequency of publication may vary from daily for national, metropolitan area, and larger city newspapers to weekly or monthly for newspapers published in smaller cities and counties. Furthermore, the newspapers may be limited to specific content relevant to particular audiences. For example, the intended audience may be college students, business people, active or retired members of the military, members of a religious denomination, political party adherents, ethnic groups, minority communities, or the like. If rhyming riddles are syndicated, they may appear in any number of the aforementioned newspapers.

In a further embodiment, the printed item may be a magazine. A rhyming riddle and a set of answer choices may be printed on one page of a magazine and the correct answer and a brief explanation may be printed on a subsequent page. Copies of the magazines may be sold nationally or regionally. Rhyming riddles may be published in a variety of topic-specific magazines. The topics may include art, business, education, entertainment, fashion, health and fitness, history and biography, hobbies, lifestyle, literature, music, news, parenting, science and technology, society and culture, sports, or the like. Furthermore, the magazine subscribers may belong to demographic groups that include children, teenagers, men, women, members of a certain profession, retirees, or the like. The rhyming riddles included in a magazine may be chosen randomly. Alternatively, they may be selected because they relate to the topic of the magazine, an article featured in the same issue of the magazine, or a subject of interest to a demographic group. Some magazines may print a number of rhyming riddles in an issue. These magazines may be especially appealing to people who need to busy themselves and may include in-flight magazines, popular waiting room magazines, or the like. If rhyming riddles are syndicated, they may appear in any number of the magazines mentioned previously.

In an additional embodiment, rhyming riddles may be the clues for a crossword puzzle printed in any of the newspapers or magazines discussed above. The rhyming riddles may not be accompanied by answer choices. A reader may solve a clue in the form of a rhyming riddle and fill the appropriate squares in the crossword grid with the letters that constitute the answer to the rhyming riddle. For example, the rhyming riddle may refer to “a subset of a branch of mathematics,” “independent development by two polymaths” and “area under a curve.” The answer is “Integral” (as in integral calculus) and the reader would add the letters INTEGRAL to the eight squares allocated to the rhyming riddle's answer. A crossword puzzle may be non-specific in scope and the rhyming riddles may concern a variety of subjects. Alternatively, a crossword puzzle may relate to the content of the newspaper or magazine that contains it. For example, if a magazine features articles about music, the crossword puzzle may relate to music in general, a particular genre of music, or a specific musician. Because these crossword puzzles have a theme, the rhyming-riddle clues may become easier to solve as the theme of the puzzle becomes evident. Rhyming riddles that have been solved may help the reader deduce the answers to other rhyming riddles.

In an embodiment, the printed item may be a booklet. A rhyming riddle and a set of answer choices may be printed on an odd-numbered page in a booklet and the correct answer and a brief explanation may be printed on the next page. Because of this arrangement, the rhyming riddle and the correct answer do not appear on facing pages of the booklet; the user has to turn the page to compare his or her answer choice to the correct answer. Alternatively, the correct answers to all the rhyming riddles and the brief explanations may be printed at the back of the booklet. The rhyming riddles included in a booklet may be randomly selected from the categories and subcategories listed in FIGS. 3A-3G. The levels of difficulty may vary in a single booklet. As an alternative, booklets may be available in a series of five, one booklet for each level of difficulty. A user may finish one booklet and start the next in the series as he or she becomes more adept at solving rhyming riddles. Instead of randomly selecting rhyming riddles, the publisher of the booklets may choose rhyming riddles from a single category or subcategory listed in FIGS. 3A-3G. To further focus the content of the booklets, the publisher may select rhyming riddles that concern a certain topic from one of the listed subcategories. For example, the topic of a booklet may be Frank Lloyd Wright and the publisher would select appropriate rhyming riddles from the subcategory 304a “Architecture—Famous Architects” included in category 304 “Architecture and Construction.” Furthermore, the booklets may be made to order. For instance, a reader may want to learn about General George S. Patton and may request the publisher to print a booklet containing rhyming riddles that relate to Patton (if such a booklet is not already available). The reader may specify the level of difficulty for the rhyming riddles to be included in the booklet based on the extent of his or her knowledge about Patton. In addition, a made-to-order booklet may be given as a gift to a family member or friend who has an interest in a particular topic.

In another embodiment, the printed item may be a tear-off calendar. There may be a page for every day of the year. A rhyming riddle and a set of answer choices may be printed on the front of a page along with the date. The correct answer and a brief explanation may be printed on the back of the page. The user may read the rhyming riddle on the page for a particular day, consider the set of answer choices, select an answer choice, flip the page, and compare his or her answer choice to the correct answer. After reading the brief explanation, the user may tear off the page and reveal the page for the next day. The rhyming riddles included in a calendar may be randomly selected and relate to a variety of topics. Alternatively, a calendar may contain rhyming riddles that concern a specific topic. For example, the rhyming riddles may be chosen from subcategories 310e (Movies), 310f (Music), 312a (Famous Deceased People), 316a-316h (Art), 324h (British History), 324i (U.S. History), 326a (Inventions), 326c-326u (Industry), 334a-334g (Medicine), 336a-336f (Military), 338e-338l (Economics), 352a-352e (Science), or the like. The rhyming riddles printed in a calendar may have different levels of difficulty. Alternatively, the level of difficulty may be the same for all the rhyming riddles included in a calendar. Hence, a user may select a calendar containing rhyming riddles with a level of difficulty commensurate with the extent of his or her knowledge about a specific topic.

In the embodiments discussed above, the rhyming riddles are a type of question to be answered by the user. The database is the source of the rhyming riddles. In addition, the database may contain other questions that are not in the rhyming riddle format. In several embodiments, the other questions are presented to a user. These embodiments are discussed below.

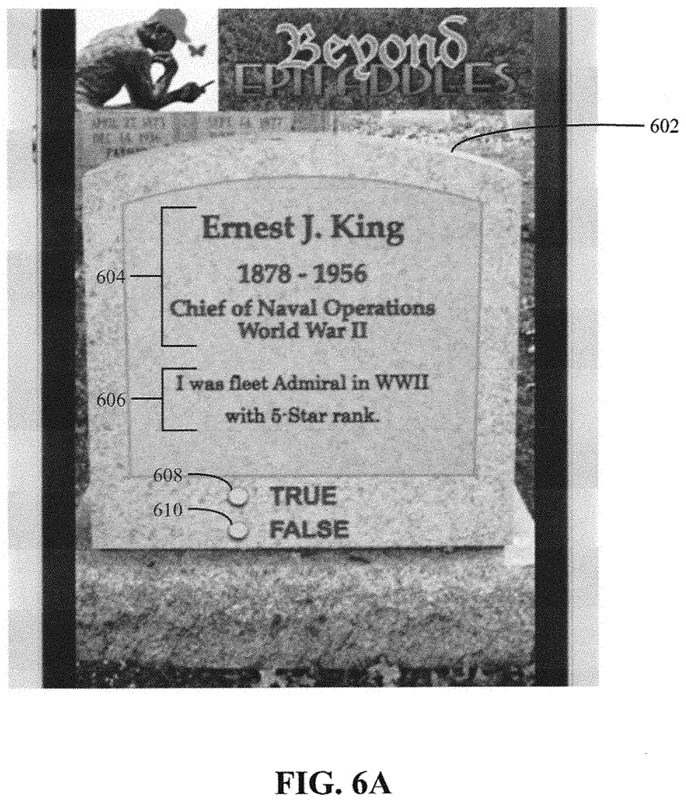

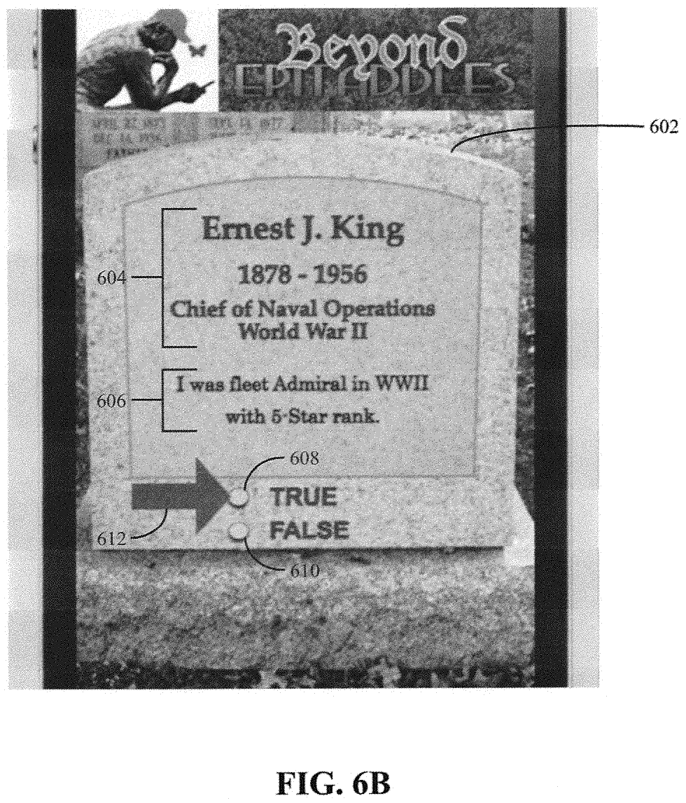

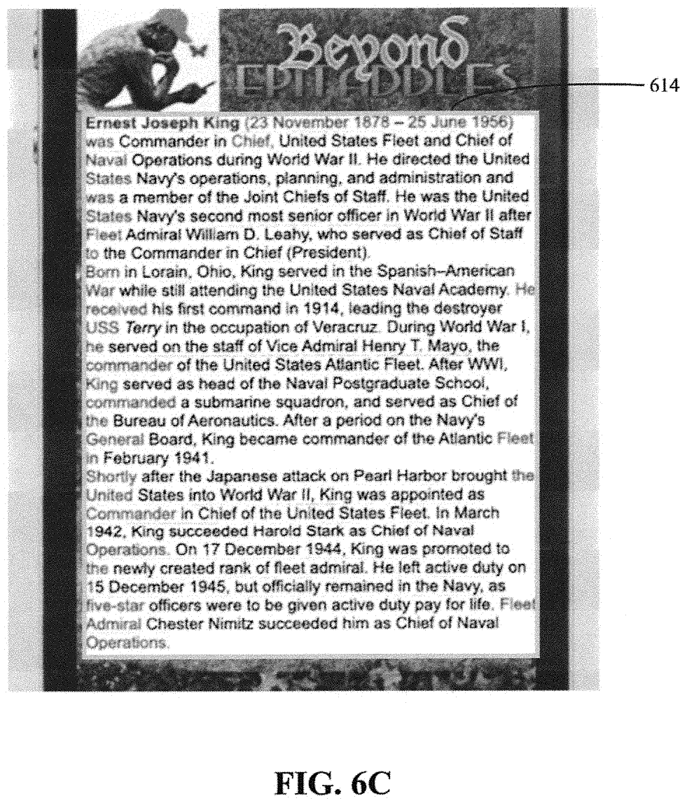

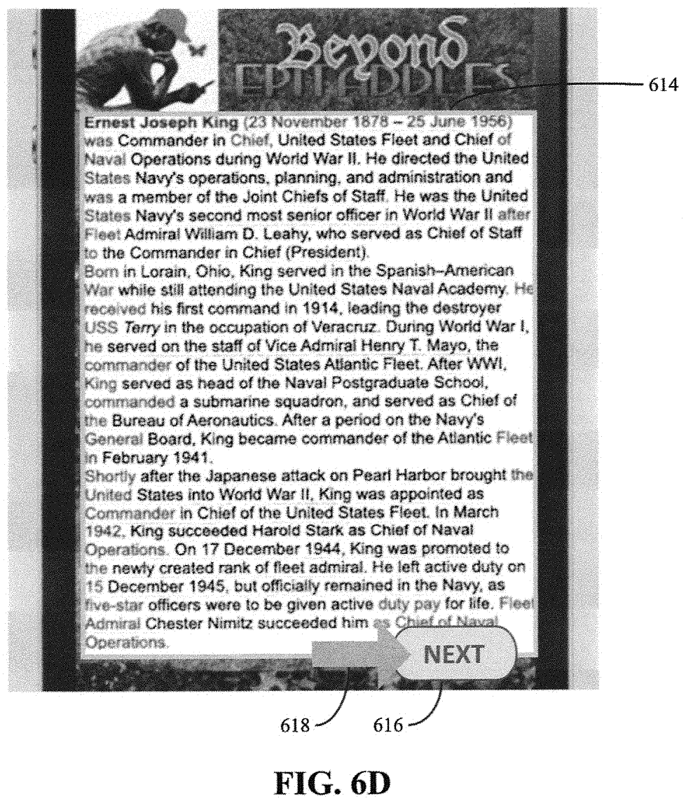

FIGS. 6A-6D are screenshots of another embodiment of the educational tool. In this embodiment, a user is presented with true or false questions that concern famous deceased people who are the subjects of rhyming riddles previously considered by the user. Hence, this embodiment reviews the content of the rhyming riddles and short biographies that were contemplated by the user during implementation of the “Epitaddles” embodiment. The present embodiment is aptly entitled “Beyond Epitaddles.”

FIG. 6A depicts one screen of a multi-screen user interface utilized in the “Beyond Epitaddles” embodiment. The screen shows a headstone 602, but information 604 replaces the epitaph. The information 604 includes “Ernest J. King,” the name of the famous deceased person who is the subject of the true or false question. The years of King's life “1878-1956” appear beneath his name. The information 604 concludes by identifying King as “Chief of Naval Operations World War II.” As such, King achieved fame and ranks among famous deceased people.

Below information 604 is statement 606, “I was fleet Admiral in WWII with a 5-Star rank.” The user has to determine if statement 606 is true or false by recalling the information he or she learned about King from rhyming riddles he or she considered and answered previously. The user selects radio button 608 if he or she believes statement 606 is true. Alternatively, the user chooses radio button 610 if he or she thinks statement 606 is false.

FIG. 6B depicts the screen that is shown once the user has selected a radio button. The screen includes the headstone 602, information 604, statement 606, radio button 608 preceding the “True” answer choice, and radio button 610 preceding the “False” answer choice as they appear on the screen shown in FIG. 6A. However, the screen shown in FIG. 6B also includes arrow 612 which indicates the correct answer choice. In FIG. 6B, the arrow 612 points to radio button 608 that precedes the “True” answer choice. Hence, the user would have been correct had he or she selected radio button 608.

FIG. 6C depicts the screen that displays a short biography of King. The headstone 602 has been replaced by a box 614 that contains the short biography. If the user selected the correct answer choice (“True”), he or she may remember at least some of the factual information presented in the rhyming riddles that concern King and the short biography serves to reinforce what he or she already knows. However, if the user chose the incorrect answer choice (“False”), he or she may remember very little of the factual information presented in the rhyming riddles and the short biography gives him or her another opportunity to learn about King.

FIG. 6D depicts the screen that takes the user to a new screen that displays another true or false question about a famous deceased person. A button 616 at the bottom right of the screen reads “Next.” As indicated by arrow 618, the user selects button 616 when he or she is ready to proceed to the next screen. The user should thoroughly review the short biography of King contained in box 614 before selecting button 616. The new screen is very similar in appearance to the screen shown in FIG. 6A. However, the information and statement concern a different famous deceased person. As before, the user selects radio button 608 preceding the “True” answer choice or radio button 610 preceding the “False” answer choice depending upon his or her assessment of the veracity of the statement. The biography of the famous deceased person appears on a screen similar in appearance to the screen shown in FIG. 6C. Once again, the “Beyond Epitaddles” embodiment allows the user to review factual information contained in rhyming riddles that he or she answered previously.

The “Beyond Epitaddles” embodiment is an effective and enjoyable way for a user to determine if he or she is utilizing the educational tool properly. A user is encouraged to frequently use this embodiment. If the user consistently selects the correct answer to the true or false questions, he or she is retaining the factual information presented in the rhyming riddles that relate to famous deceased people. In contrast, if the user consistently answers the true or false questions incorrectly, he or she is not retaining the factual information contained in the rhyming riddles. For example, the user may not be totally immersed in the learning experience created by the educational tool. He or she may read a rhyming riddle quickly and spend little time considering the answer choices. Consequently, any acquired information may not be retained. To improve retention, the user should take the time to contemplate and comprehend the factual information presented in a rhyming riddle. The expenditure of extra time may result in enhanced retention of the factual information about the famous deceased person. As a result, the user may see a steady increase in the percentage of true or false questions he or she answers correctly. Furthermore, the user may be more likely to retain factual information presented in rhyming riddles that concern topics other than famous deceased people. Ultimately, the user may become more adept at retaining factual information in his or her everyday life. Hence, the user's performance while utilizing the “Beyond Epitaddles” embodiment may provide the impetus to change the way he or she processes information to be retained.

There is yet another embodiment of the educational tool that allows the user to review factual information contained in rhyming riddles he or she has already considered. This embodiment concerns aphorisms, quotes, or wise words attributable to famous people who are now deceased. It is entitled “Who Said This?”

Once the present embodiment has been selected, the user may be presented with a screen that displays a headstone with an inscription on it. The inscription may include a statement in quotation marks. A rhyming riddle about the famous deceased person who made the statement may have included the statement in its entirety or at least a reference to the statement. The statement may be followed by a question asking for attribution. A set of answer choices may appear below the question. The set of answer choices may include several famous deceased people. The objective is to select the person who made the statement. The incorrect answer choices may be selected for inclusion in the set of answer choices because they might have made the quoted statement or similar statements.

A radio button may precede each of the answer choices. The user may select the radio button corresponding to the answer choice he or she believes is the source of the quoted statement. The user's selection may be based on his or her recall of rhyming riddles he or she considered while using the “Epitaddles” embodiment of the educational tool. Regardless of the answer choice selected, the user may be taken to an informational screen that displays facts about the correct answer. If the user chooses the correct answer, he or she may be taken to the informational screen immediately. If the user selects an incorrect answer choice, an arrow may appear and point to the correct answer and then the informational screen may be displayed. The informational screen may repeat the name of the famous person who made the quoted statement and include his or her years of life and the reason for his or her fame. A screen that displays a short biography of the deceased person may follow the informational screen. The short biography may reiterate the quoted statement and provide the context in which it was made.

For example, the user selects the “Who Said This?” embodiment and the software application displays a screen with a headstone on it. The headstone's inscription includes the statement, “No one can make you feel inferior without your consent.” The statement is followed by the question, “Who said this?” Below the question are four answer choices: “Simone de Beauvoir,” “Katherine Johnson,” “Eleanor Roosevelt,” and “Ayn Rand.” Each answer choice is preceded by a radio button.

If the user selects the radio button that precedes the correct answer “Eleanor Roosevelt,” the inscription on the headstone changes from the quoted statement, question, and answer choices to information about Eleanor Roosevelt. If the user selects any of the other radio buttons, the next screen displays an arrow that points to the correct answer. The screen with the arrow is followed by the screen that shows the headstone inscribed with information about Roosevelt. Her name is displayed near the top of the headstone's face. The years of her life “1884-1962” appear beneath her name. The reason for her fame is listed last. She is described as an “American Political Figure, Diplomat, and Activist.” The informational screen is followed by a screen that displays a short biography of Roosevelt.

Use of the present embodiment may offer several benefits similar to the benefits that result from use of the “Beyond Epitaddles” embodiment. The “Who Said This?” embodiment is also an effective and enjoyable way for a user to review factual information contained in rhyming riddles about famous deceased people. However, the consistent selection of incorrect answer choices may indicate that the user is having difficulty retaining factual information. Once aware of the problem, the user may take measures to improve his or her memory. For example, the user may benefit from more frequent use of the educational tool. As discussed above, use of the educational tool has a positive impact on memory. The rhyming riddle format stimulates primitive neural pathways in the brain associated with the retention of information. Frequent utilization of the educational tool promotes and reinforces the use of the primitive pathways. As a result, a user's memory is improved.

The educational tool may provide a comprehensive approach to improving a user's memory. Embodiments like “Beyond Epitaddles” and “Who Said This?” may diagnose a problem with the retention of factual information. The educational tool may correct the problem when used more frequently. As more and more rhyming riddles are solved, a user's ability to retain facts may improve. Furthermore, the educational tool may evaluate the effectiveness of the user's efforts to improve fact retention. As the user becomes more proficient at retaining factual information, he or she should notice a steady improvement in his or her capacity to select the correct answer to the questions posed by the “Beyond Epitaddles” and “Who Said This?” embodiments. Hence, the educational tool may be fully integrated where the retention of factual information is concerned. It may diagnose problems, provide measures to correct the problems, and evaluate the effectiveness of the corrective measures taken by the user.

In the “Beyond Epitaddles” and “Who Said This?” embodiments, the user has to rely on his or her memory to answer a question that is based on a previously encountered rhyming riddle. Other embodiments may also require the user to remember a rhyming riddle and its contents. In one such embodiment, the user has to recall a word that appears in a rhyming riddle he or she has already solved. When presented with the rhyming riddle, the user was probably unfamiliar with the word and had to use context to determine its meaning. The present embodiment may review the definition of the word. The objective is the addition of the word to the user's vocabulary. Accordingly, the embodiment is entitled “Vocabulary Builder.” This embodiment may focus on a word from a rhyming riddle that concerns any topic in any category or subcategory listed in FIGS. 3A-3G.

Once the present embodiment has been selected, the user may be presented with a screen that displays two options. If the first option is chosen, the next screen may display a definition and a set of words. Each word is preceded by a radio button. The user may select the radio button that corresponds to the word he or she thinks has the displayed definition. If the user chooses the correct word, it is used in example sentences displayed on the next screen. If an incorrect word is chosen, an arrow may appear on the screen and point to the correct word before the screen showing the example sentences is displayed.

Alternatively, if the user wants more of a challenge, he or she may select the second option. The next screen may display the definition. However, an empty box or a blank line may replace the set of words. The user may position the cursor in the box or on the line and type the word he or she thinks has the displayed definition. If the user types the correct word, the screen that displays the example sentences may appear. If the user types any other word, the next screen may display the correct word and the example sentences.

For instance, the user chooses the first option and is presented with a screen that displays the definition, “the use of a word that imitates, resembles, or suggests the sound it describes.” Below the definition are four words: “alliteration,” “onomatopoeia,” “assonance,” and “consonance.” The word “onomatopoeia” has the displayed definition. If the user selects the radio button that precedes “onomatopoeia,” it is used in the example sentences that appear on the next screen. If the user selects any other word, an arrow appears on the screen and points to “onomatopoeia” before the screen showing the example sentences is displayed. An example sentence might read, “In his poem ‘The Bells,’ Edgar Allan Poe uses onomatopoeia to mimic the sounds made by bells.”

When the first option is selected, the user has to recognize the correct word included in the set of four words. The second option requires the user to recall the correct word; it does not appear on the screen along with its definition. Hence, the second option is more challenging than the first option. For example, the user chooses the second option and is presented with a screen that displays the definition, “inflammation of the mucous membrane of the nose.” There is an empty box below the definition. The user is supposed to type the correct word in this box. The word “rhinitis” has the displayed definition. If the user types “rhinitis,” it is used in the example sentences that appear on the next screen. If the user types any other word, “rhinitis” appears on the next screen along with the example sentences. An example sentence might read, “Rhinitis is usually caused by the common cold or a seasonal allergy.”

Described herein is a software application that uses rhyming riddles to impart factual information. The software application may enable a user to choose a category and a level of difficulty to obtain a chosen category and a chosen level of difficulty. A database that stores rhyming riddles may be accessed. The rhyming riddles may be created by a plurality of users. The database may be requested to randomly select a rhyming riddle that relates to a topic in the chosen category and has the chosen level of difficulty. A screen may be used to display the rhyming riddle and a set of answer choices that includes the correct answer to the rhyming riddle. The screen may be part of the user's desktop computer, portable electronic device, or other electronic device having sufficient processing capability to execute the software application. The user may be allowed to select an answer choice from the set of answer choices and the software application may determine if the selected answer is the correct answer to the rhyming riddle.

Frequent use of the educational tool may have beneficial effects on the user's cognitive abilities. For example, the consideration and solution of rhyming riddles may improve the user's problem-solving skills. Furthermore, the development of these skills may be self-perpetuating because the mesolimbic pathway releases dopamine into the nucleus accumbens, the brain's reward center, when rhyming riddles are solved. The positive feelings that ensue may motivate the user to solve even more rhyming riddles. In addition, use of the educational tool may have a positive impact on the user's memory. As a result, the user may be better able to retain the factual information included in the rhyming riddles he or she considers and solves.

The user may customize his or her interaction with the educational tool. He or she may select the category or subcategory and level of difficulty for the rhyming riddles he or she will attempt to solve. In addition, there are several options available to the user that narrow the scope of the rhyming riddles presented to him or her. The user may focus the topic of the rhyming riddles to the extent necessary to meet his or her learning objectives. Moreover, the educational tool may be utilized individually, collaboratively, or competitively. Regardless of the type of use, the educational tool may impart knowledge about any topic in the various categories and subcategories. There may be additional ways the educational tool fosters learning. A user may be regularly encouraged to write rhyming riddles about a topic of interest to him or her. The process of composing a rhyming riddle may add to the user's knowledge of the topic.

The user may also attempt to solve rhyming riddles presented in printed items that range from an individual card to a board game and from a topic-specific booklet to a nationally distributed newspaper or magazine. The same database and software application may be used whether a rhyming riddle appears on a screen or in a printed item. Furthermore, the database may contain review questions in formats other than the rhyming riddle format. Several embodiments of the educational tool may present the user with the review questions. To answer these questions, the user has to recall factual information included in rhyming riddles he or she has already solved. The educational tool may identify a problem with the retention of factual information if the user consistently answers the review questions incorrectly. The user may correct the problem by solving more rhyming riddles. As the user's ability to retain factual information improves, there should be a steady increase in the percentage of review questions he or she answers correctly. Hence, the educational tool may identify a problem with the retention of factual information, provide measures to correct the problem, and evaluate the effectiveness of the corrective measures taken by the user. In short, the educational tool may offer the user a comprehensive approach to improving his or her ability to retain factual information.

The embodiments disclosed herein may be implemented as instructions stored on a tangible, non-transitory, machine-readable medium. These instructions may be read and executed by a computing platform to perform the functions described above. A tangible, non-transitory, machine-readable medium may include any tangible, non-transitory medium for storing information in a form readable by a machine, e.g., a computer. Examples of a tangible, non-transitory, machine-readable medium may include read only memory (ROM), random access memory (RAM), magnetic disk storage media, optical storage media, flash memory devices, or the like.

An embodiment is an implementation or example. Reference to “an embodiment,” “another embodiment,” “yet another embodiment,” “one embodiment,” “one such embodiment,” “other embodiments,” “additional embodiments,” “even more embodiments,” “some embodiments,” “most embodiments,” “previous embodiments,” or “several embodiments” indicates that a particular feature or characteristic is included in at least some embodiments, but not necessarily in all embodiments, of the present techniques. The various occurrences of “an embodiment,” “another embodiment,” “yet another embodiment,” “other embodiments,” “additional embodiments,” or “some embodiments” are not necessarily referring to the same embodiments.

Not all features, characteristics, or the like described and illustrated herein need to be included in a particular embodiment or embodiments. For example, if the specification states a feature or characteristic “may” be included, that particular feature or characteristic is not required to be included. If the specification or claims refer to “a” or “an” element, that does not mean there is only one of the element. If the specification or claims refer to “an additional” element, there may be more than one of the additional element.

Some embodiments have been described by referring to particular implementations. However, other implementations are possible. The implementations of the present techniques are not limited to those disclosed herein. Additionally, the arrangement or order of features described herein or illustrated in the figures need not be arranged or sequenced in the particular way described or illustrated. Other arrangements or sequences are possible.

In the systems shown in the figures, some elements may have the same reference number to suggest that the elements are similar. Alternatively, elements shown in the figures may have different reference numbers to suggest that the elements are different. However, an element may be flexible enough to have different implementations and work with some or all of the systems described herein or shown in the figures. Various elements described herein or depicted in the figures may be designated a first element, a second element, etc. It is arbitrary which element is referred to as the first element, the second element, and so on.

Details of the aforementioned examples may be used in one or more embodiments. For example, all optional features of the logic flow diagram shown in FIGS. 2A-2C and described above may also be implemented in the embodiment shown in FIGS. 4A-4P and described herein. Furthermore, flow diagrams have been used herein to describe embodiments. However, the present techniques are not limited to those diagrams or to the corresponding descriptions. For example, flow need not progress through each box or in exactly the same order as illustrated and described herein.

The present techniques are not restricted to the particular details described above. Those skilled in the art having the benefit of this disclosure will appreciate that many other variations of the foregoing descriptions and accompanying figures are possible and remain within the scope of the present techniques. Accordingly, the scope of the present techniques is defined by the following claims and any amendments thereto.

What is claimed is:

1. At least one non-transitory computer-readable medium, comprising instructions to direct at least one processor to:
enable a user to choose a category and a level of difficulty to obtain a chosen category and a first level of difficulty;
access a database that stores rhyming riddles created by a plurality of users;
request the database to randomly select a first rhyming riddle that concerns a topic in the chosen category and has the first level of difficulty;
use a screen to display the first rhyming riddle and a first set of answer choices that includes a correct answer to the first rhyming riddle;
allow the user to select a first answer choice from the first set of answer choices; and
determine if the first answer choice is the correct answer.

2. The at least one non-transitory computer-readable medium of claim 1, wherein the chosen category comprises people, works, happenings, places, and principles.

3. The at least one non-transitory computer-readable medium of claim 1, wherein:
the first level of difficulty is an integer that has a minimum value of one and a maximum value of five and
the first rhyming riddle becomes more difficult to solve as the first level of difficulty increases from one to five.

4. The at least one non-transitory computer-readable medium of claim 1, wherein the screen comprises a screen on a desktop computer, a portable electronic device, an electronic device having sufficient processing capability, and a sound stage used to film a television game show.

5. The at least one non-transitory computer-readable medium of claim 1, wherein the first set of answer choices contains four answer choices.

6. The at least one non-transitory computer-readable medium of claim 1, further comprising instructions to direct the at least one processor to:
increase a score of the user by the first level of difficulty when the first answer choice is the correct answer and
present the user with an option to learn more about the correct answer.

7. The at least one non-transitory computer-readable medium of claim 1, further comprising instructions to direct the at least one processor to:
calculate a first number of remaining points by subtracting one from the first level of difficulty when the first answer choice is not the correct answer and
determine if the first number of remaining points is equal to zero.

8. The at least one non-transitory computer-readable medium of claim 7, further comprising instructions to direct the at least one processor to:
inform the user that no more points are available when the first number of remaining points is equal to zero and
present the user with the option to learn more about the correct answer.

9. The at least one non-transitory computer-readable medium of claim 7, further comprising instructions to direct the at least one processor to:
request the database to randomly select a second rhyming riddle when the first number of remaining points is not equal to zero, wherein the second rhyming riddle concerns the topic in the chosen category, has a same answer as the first rhyming riddle, and has a second level of difficulty equal to the first level of difficulty minus one;
use the screen to display the second rhyming riddle and a second set of answer choices equal to the first set of answer choices minus the first answer choice;
allow the user to select a second answer choice from the second set of answer choices; and
determine if the second answer choice is the correct answer.

10. The at least one non-transitory computer-readable medium of claim 9, further comprising instructions to direct the at least one processor to:
increase the score of the user by the second level of difficulty when the second answer choice is the correct answer and
present the user with the option to learn more about the correct answer.

11. The at least one non-transitory computer-readable medium of claim 9, further comprising instructions to direct the at least one processor to:
calculate a second number of remaining points by subtracting one from the first number of remaining points when the second answer choice is not the correct answer and
determine if the second number of remaining points is equal to zero.

12. The at least one non-transitory computer-readable medium of claim 11, further comprising instructions to direct the at least one processor to:
inform the user that no more points are available when the second number of remaining points is equal to zero and
present the user with the option to learn more about the correct answer.

13. The at least one non-transitory computer-readable medium of claim 11, further comprising instructions to direct the at least one processor to:
request the database to randomly select a third rhyming riddle when the second number of remaining points is not equal to zero, wherein the third rhyming riddle concerns the topic in the chosen category, has the same answer as the first rhyming riddle and the second rhyming riddle, and has a third level of difficulty equal to the second level of difficulty minus one;
use the screen to display the third rhyming riddle and a third set of answer choices equal to the second set of answer choices minus the second answer choice;
allow the user to select a third answer choice from the third set of answer choices; and
determine if the third answer choice is the correct answer.

14. The at least one non-transitory computer-readable medium of claim 13, further comprising instructions to direct the at least one processor to:
increase the score of the user by the third level of difficulty when the third answer choice is the correct answer and
present the user with the option to learn more about the correct answer.

15. The at least one non-transitory computer-readable medium of claim 13, further comprising instructions to direct the at least one processor to present the user with the option to learn more about the correct answer when the third answer choice is not the correct answer.

16. A method for improving problem-solving skills, comprising:
developing a database that stores rhyming riddles created by a plurality of contributors;
choosing a category and a level of difficulty to obtain a chosen category and a chosen level of difficulty;
requesting the database to randomly select a rhyming riddle that concerns a topic in the chosen category and has the chosen level of difficulty;
printing the rhyming riddle, a set of answer choices that includes a correct answer to the rhyming riddle, and the correct answer to obtain a printed item; and
making the printed item available to a user.

17. The method of claim 16, wherein the chosen category comprises people, works, happenings, places, and principles.

18. The method of claim 16, wherein:
the chosen level of difficulty is an integer that has a minimum value of one and a maximum value of five and
the rhyming riddle becomes more difficult to solve as the chosen level of difficulty increases from one to five.

19. The method of claim 16, wherein the set of answer choices contains four answer choices.

20. The method of claim 16, wherein the printed item comprises a scratch-off card, a color-coded card, a set of color-coded cards, a box of color-coded cards, a page in a newspaper, a page in a magazine, a crossword puzzle, a booklet, or a tear-off calendar.

21. The method of claim 16, wherein the user:
reads the rhyming riddle and the set of answer choices printed on the printed item;
selects an answer from the set of answer choices to obtain a selected answer; and
compares the selected answer to the correct answer printed on the printed item to determine if the selected answer is the correct answer to the rhyming riddle.
